(19) United States
(12) Patent Application Publication
(10) Pub. No.: US 2026/0367460 A1
(43) Pub. Date: Nov. 19, 2026

(54) ELECTROPHORESIS DISPLAY WITH OVERLAPPED COLOR BLOCKS

(71) Applicant: SUPERC-TOUCH CORPORATION, New Taipei City (TW)

(72) Inventors: Hsiang-Yu LEE, New Taipei City (TW); Shang CHIN, New Taipei City (TW); Ping-Tsun LIN, New Taipei City (TW); Chia-Cheng LEI, New Taipei City (TW); Kun-Yu CHEN, New Taipei City (TW)

(73) Assignee: SUPERC-TOUCH CORPORATION, New Taipei City (TW)

(21) Appl. No.: 19/672,955

(22) Filed: May 11, 2026

(30) Foreign Application Priority Data
May 15, 2025 (TW) 114118271

(51) Int. Cl. G02F 1/1677; G02F 1/1368; G02F 1/167

(52) U.S. Cl. CPC G02F 1/1677; G02F 1/1368; G02F 1/167

(57) ABSTRACT

An electrophoresis display includes a first substrate including a thin film transistor layer and a pixel electrode layer, a color filter layer, a second substrate and a display material layer sandwiched between the first substrate and the second substrate. The pixel electrode layer includes a plurality of pixel electrodes. The color filter layer includes multiple color filter unit sets. Each color filter unit set includes at least six color filter blocks of different colors and includes multiple primary-color color filter blocks and multiple non-primary-color color filter blocks. Each color filter block has a one-to-one correspondence with a pixel electrode. Each of the primary-color color filter blocks is formed by overlapping two non-primary-color color blocks with different colors. The display material layer is filled with a colloidal solution containing charged color particles of at least one color.

### CROSS-REFERENCE TO RELATED APPLICATIONS

This application claims the benefit of priority to Taiwanese Patent Application No. 114118271, filed May 15, 2025, the entire disclosures of which are incorporated herein by reference.

### BACKGROUND

### Technical Field

The present disclosure relates to an electrophoresis display, especially to an electrophoresis display with overlapped color blocks.

### Description of Related Art

An ideal electronic paper display has features of light weightiness, compact size, energy-saving, and can be made flexible or rollable. The electronic paper display has the characteristic of retaining image after the power is turned off, so it has already been widely used in books, labels, posters, bulletin boards, and other applications. Various electronic paper technologies capable of achieving these goals have been proposed in the past. Thes electronic paper displays are, for example, quick response liquid powder displays and cholesteric liquid crystal displays. However, in view of practical system-integration image display quality, complexity of electronic driving system design, and mass-production stability, electrophoresis displays (EPD) remain the mainstream. In addition, as user needs evolve, color electronic paper has gradually become a key focus of development. Color electronic paper is a color display with bistable characteristics. The color electronic paper does not consume power when maintaining a displayed image and consumes few power when updating the display. In comparison with LCD screens, which must be continuously powered, color electronic paper can significantly reduce the power consumption of the display. The advantages of color electronic paper further include environmentally friendly, power-saving, eye-friendly, and readable under sunlight. Because both electronic paper and reflective LCDs present images by reflecting ambient light, rather than relying on the active backlight of conventional backlit LCDs that emits relatively high levels of blue light, users feel more comfortable for the eyes and less fatiguing when viewing electronic paper or reflective LCD displays.

The existing color electronic paper technology can imitate the way LCDs work by using the colored photoresist on a color filter (for example, RGB primary-color photoresists) as color filter blocks. Namely, the color filter blocks filter part of the spectrum of white light to provide colored light. The technology only requires a black-and-white electronic ink film combined with a color filter. However, a serious problem lies in that for the incoming white incident light, the color filter blocks absorb the light with about two-thirds of the bandwidth range, leaving only about one-third of the bandwidth of the incident light to be reflected. This results in the image with noticeably darker color. Traditional LCDs overcome this problem by using a high-brightness backlight to compensate the loss of light caused by above color filtering mechanism, thereby maintaining normal display brightness. However, the trade-off is high power consumption. The color electronic paper is not equipped with backlight, so it cannot solve this problem. Despite more than ten years of R&D in the industry, there is still no fundamental solution. At present, color electronic paper that uses a color-filter approach has to rely on a front light to compensate the brightness. Due to mechanical constraints and the principles of reflection, the effect is far inferior to the backlight of an LCD, and once the front light is turned on, the eye-comfort advantage of color electronic paper is greatly diminished.

FIG. 9 shows a sectional view of a conventional color electrophoresis display 100. As shown in FIG. 9, the color electrophoresis display 100 includes, from top to bottom, an upper glass substrate 16, a color filter layer CF (for example including red color filter blocks R, green color filter blocks G, and blue color filter blocks B), an optical adhesive 13, an opposite substrate 12 (which may be a transparent plastic substrate), a common electrode layer 14 (which may be a transparent conductive electrode layer), a display material layer 20 (for example, an electrophoresis layer), a pixel electrode layer PEL (including pixel electrodes PE1, PE2, and PE3), a thin-film transistor layer 30, and a control substrate 10 (which may be a transparent glass substrate). As shown in FIG. 9, the display material layer 20 includes a plurality of hollow cavities 22 (only one is illustrated), and a colloidal solution 24 filled in each hollow cavity 22. The colloidal solution 24 contains a plurality of suspended charged color particles 26 (for example, charged black particles 26B and charged white particles 26W). The hollow cavity 22 serves as a container for the electronic ink (or electrophoresis material). For example, each hollow cavity 22 is a micro-cup or a micro chamber formed with organic polymer material and is used to contain the charged color particles 26.

The common electrode layer 14 is generally connected to a ground potential (0 V) to provide a common voltage Vcom, and the control substrate 10 below has a driving circuit layer (not shown) and the thin-film transistor layer 30 thereon, which are typically formed with a panel TFT array process. The charged color particles 26 carry electric charges of predetermined polarity; for example, the charged black particles 26B are positively charged and the charged white particles 26W are negatively charged. By driving the thin-film transistor layer 30 via the driving circuit layer to control the electrical state and voltage level of each pixel electrode PE1-PE3. Each pixel electrode can be controlled to attract the charged black particles 26B and repel the charged white particles 26W such that the corresponding pixel displays white color on the viewing side opposite to the pixel electrode. Alternatively, each pixel electrode can be controlled to attract the charged white particles 26W and repel the charged black particles 26B such that the corresponding pixel displays a desired image on the display surface, for example, on the surface near the upper glass substrate 16.

Electrophoresis displays with color filter layer array uses area sharing and color mixing to generate visually perceived colors. The available display area is shared among primary colors such as red/green/blue (RGB) or red/green/blue/white (RGBW), and the color filter layer can be arranged in one-dimensional (stripe) or two-dimensional (2×2) repeating patterns. As long as the areas of the three sub-pixels (in the case of an RGB display) or four sub-pixels (in the case of an RGBW display) are sufficiently small, they can achieve higher resolution and will visually blend together into a single pixel with a uniform color.

As shown in FIGS. 1A and 1B, which respectively shows an example of conventional color filter layer CF. As shown in FIG. 1A, this color filter layer CF is, for example, an RGB primary-color filter layer, in which each color filter includes substantially rectangular primary-color filter blocks. However, as shown in FIG. 1B, in order to solve the adverse effect of reduced reflected light due to the filtering out light by the filter blocks and having bad effect of a darker image, the coverage area of the filter blocks is reduced to increase the reflected light. The area of the filter blocks is only about one-half of the original area, and the remaining one-half is a light-transmitting area without color filtering function.

Referring to FIG. 1C, this figure shows the arrangement for displaying the three colors red, green, and blue using the color filter layer CF of FIGS. 1A and 1B. Refer also to FIG. 9, if a display unit is to display red color, the pixel electrode PE1 corresponding to the red color filter block R, under the control of the thin-film transistor layer 30, is driven to apply a driving voltage attracting the charged white particles 26W to the viewing side to reflect light, so that the area corresponding to the red color filter block R emits red light (half of the area emits red light and the remaining half appears white). The pixel electrodes PE2 and PE3 corresponding to the green color filter block G and the blue color filter block B, under the control of the thin-film transistor layer 30, are driven to apply driving voltages attracting the charged black particles 26B to not reflect light, causing the areas corresponding to the green color filter block G and the blue color filter block B to display black color (K), thereby making this pixel appear red color. In this situation, the color and brightness of this display unit including three pixels as those shown in FIG. 1A can be expressed as 0.5R+0.5W+1Black+1Black=0.5R+0.5W+2Black. This is analogous to use 0.5 parts red pigment, 0.5 parts white pigment, and 2 parts black pigment in painting to obtain the resulting color. This is the main reason why products using this type of technology display a darkish red when showing red.

Similarly, if a display unit is to display green color, the corresponding pixel electrodes PE1-PE3 can be controlled in a similar manner, namely, the pixel electrode PE2 corresponding to the green color filter block G attracts the charged white particles 26W to the viewing side to reflect light. In this situation, the color and brightness of this display unit including three pixels can be expressed as 0.5G+0.5W+1Black+1Black=0.5G+0.5W+2Black.

If a display unit is to display blue color, the corresponding pixel electrodes PE1-PE3 can likewise be controlled so that the pixel electrode PE3 corresponding to the blue color filter block B attracts the charged white particles 26W to the viewing side to reflect light. In this situation, the color and brightness of this display unit including three pixels can be expressed as 0.5B+0.5W+1Black+1Black=0.5B+0.5W+2Black. Although this conventional technology improves brightness, it sacrifices color saturation, resulting in a grayed-out effect approaching so-called Morandi colors.

Referring to FIG. 1D, this figure shows the arrangement for displaying the three colors yellow (Y), magenta (M), and cyan (C) using the color filter layer CF shown in FIGS. 1A and 1B. If a display unit is to display yellow color, the pixel electrode PE1 corresponding to the red color filter block R and the pixel electrode PE2 corresponding to the green color filter block G, under the control of the driving circuit layer 30, are driven to apply a driving voltage attracting the charged white particles 26W to the viewing side to reflect light, while the pixel electrode PE3 corresponding to the blue color filter block B, under the control of the thin-film transistor layer 30, is driven to apply a driving voltage attracting the charged black particles 26B to not reflect light. In this way, the area corresponding to the blue color filter block B displays black color (K), while the areas corresponding to the red color filter block R and the green color filter block G respectively display red color (half of the area emitting red light and the remaining half appearing white) and green color (half of the area emitting green light and the remaining half appearing white), thus additively combining those colors to form yellow color. In this situation, the color and brightness of this display unit including three pixels can be expressed as 0.5R+0.5W+0.5G+0.5W+1Black=0.5Y+1W+1Black. This is analogous to use 0.5 parts yellow pigment, 1 part white pigment, and 1 part black pigment in painting to obtain the resulting color. This is the main reason why the displayed yellow appears grayish-white.

If a display unit is to display magenta color, the corresponding pixel electrodes PE1-PE3 can be controlled in a similar manner, namely, the pixel electrode PE1 corresponding to the red color filter block R and the pixel electrode PE3 corresponding to the blue color filter block B are controlled to attract the charged white particles 26W to the viewing side. In this situation, the color and brightness of this display unit including three pixels can be expressed as 0.5R+0.5W+0.5B+0.5W+1Black=0.5M+1W+1Black.

If a display unit is to display cyan color, the corresponding pixel electrodes PE1-PE3 can likewise be controlled, namely, the pixel electrode PE2 corresponding to the green color filter block G and the pixel electrode PE3 corresponding to the blue color filter block B are controlled to attract the charged white particles 26W to the viewing side. In this situation, the color and brightness of this display unit including three pixels can be expressed as 0.5B+0.5W+0.5G+0.5W+1Black=0.5C+1W+1Black. Although this type of color filter layer CF shown in shown in FIGS. 1A and 1B improves brightness, it sacrifices color saturation. Moreover, when displaying yellow, magenta, and cyan color, the color saturation is even worse, with red, blue, and green appearing dark, and yellow, cyan, and magenta appearing grayish-white. This results in severe distortion of image colors.

Referring to FIG. 1E, this figure shows the arrangement for displaying white (W) and black (K) color using the color filter layer CF of FIGS. 1A and 1B. If a display unit is to display white color, the pixel electrode PE1 corresponding to the red color filter block R, the pixel electrode PE2 corresponding to the green color filter block G, and the pixel electrode PE3 corresponding to the blue color filter block B, under the control of the thin-film transistor layer 30, are driven to apply a driving voltage attracting the charged white particles 26W to the viewing side to reflect light. Therefore, this pixel color is formed by the additive combination of the three primary colors red, green, and blue to become white. In this situation, the color and brightness of this display unit including three pixels can be expressed as 0.5R+0.5W+0.5G+0.5W+0.5B+0.5W=(0.5R+0.5G+0.5B)+1.5W=2W.

If a pixel is to display black, the pixel electrode PE1 corresponding to the red color filter block R, the pixel electrode PE2 corresponding to the green color filter block G, and the pixel electrode PE3 corresponding to the blue color filter block B, under the control of the thin-film transistor layer 30, are driven to apply a driving voltage attracting the black particles 26B to the viewing side to not reflect light. Therefore, the areas corresponding to these three RGB color filter blocks display black color (K).

However, the prior-art techniques used for the color filter layer (CF) of reflective liquid crystal displays or electrophoresis displays still have much room for improvement.

### SUMMARY

It is an object of the present invention to provide an electrophoresis display with overlapped color blocks.

Accordingly, the electrophoresis display of the present disclosure includes:
a first substrate comprising a first face and a second face, a thin-film transistor layer and a pixel electrode layer arranged on the second face, the thin-film transistor layer comprising a plurality of thin-film transistors, a plurality of gate lines, and a plurality of data lines, the pixel electrode layer comprising a plurality of pixel electrodes;
a color filter layer comprising a plurality of color filter unit sets, each of the color filter unit sets comprising at least six color filter blocks with different colors, the filter color blocks with different colors comprising a plurality of primary-color color filter blocks and a plurality of non-primary-color color filter blocks, each of the color filter blocks having one-to-one correspondence with one of the pixel electrodes, wherein each of the primary-color color filter blocks is formed by overlapping two non-primary-color color blocks with different colors;
a second substrate comprising a third face and a fourth face; and
a display material layer sandwiched between the first substrate and the second substrate, the display material layer being filled with a colloidal solution containing charged color particles of at least one color.

### BRIEF DESCRIPTION OF THE DRAWINGS

FIGS. 1A and 1B show conventional color filter layer.

FIG. 1C shows a color-mixing way for displaying the three colors red, green, and blue by the color filter layer of FIGS. 1A and 1B.

FIG. 1D shows a color-mixing way for displaying the three colors yellow (Y), magenta (M), and cyan (C) by the color filter layer of FIGS. 1A and 1B.

FIG. 1E shows a color-mixing way for displaying white (W) and black (K) by the color filter layer of FIGS. 1A and 1B.

FIG. 2A is a schematic diagram of a color filter layer applicable to a color display device having a color filter layer according to one embodiment of the present disclosure.

FIG. 2B is a schematic diagram of a color filter layer applicable to a color display device having a color filter layer according to another embodiment of the present disclosure.

FIGS. 3A to 3G are schematic diagrams of color filter layers applicable to color display devices having a color filter layer according to other embodiments of the present disclosure.

FIGS. 3H to 3J are schematic diagrams of color blocks used in the present disclosure to overlap to form primary-color color filter blocks

FIG. 4A shows a color-mixing way for displaying the three colors red, green, and blue by the color filter layer of FIG. 2A.

FIG. 4B shows a color-mixing way for displaying the three colors yellow (Y), magenta (M), and cyan (C) by the color filter layer of FIG. 2A.

FIG. 4C shows a color-mixing way for displaying white (W) and black (K) by the color filter layer of FIG. 2A.

FIG. 5A is a schematic diagram of a color display device having a color filter layer according to one embodiment of the present disclosure.

FIG. 5B is a schematic diagram of a color display device having a color filter layer according to another embodiment of the present disclosure.

FIG. 5C is a schematic diagram of a color display device having a color filter layer according to still another embodiment of the present disclosure.

FIG. 5D is a schematic diagram of a color display device having a color filter layer according to still another embodiment of the present disclosure.

FIG. 6A is a schematic diagram of a color display device having a color filter layer according to still another embodiment of the present disclosure.

FIG. 6B is a schematic diagram of a color display device having a color filter layer according to still another embodiment of the present disclosure.

FIG. 7A is a schematic diagram of a color display device having a color filter layer according to still another embodiment of the present disclosure.

FIG. 7B is a schematic diagram of a color display device having a color filter layer according to still another embodiment of the present disclosure.

FIG. 7C is a schematic diagram of a color display device having a color filter layer according to still another embodiment of the present disclosure.

FIGS. 8A and 8B show the structure and process description of the thin-film transistor layer and related components on the control substrate side according to an embodiment of the present disclosure.

FIG. 9 is a schematic diagram of a conventional color electrophoresis display.

FIG. 10A is a top view of the micro-cup partition and the associated color filter layer of a conventional electrophoresis display.

FIG. 10B is a top view of a micro-partition structure according to one embodiment of the present disclosure.

FIG. 10C is another top view of a micro-partition structure according to one embodiment of the present disclosure.

FIG. 10D is a top view of a micro-partition structure according to another embodiment of the present disclosure.

FIGS. 11A to 11C are schematic process diagrams of manufacturing a micro-partition structure according to one embodiment of the present disclosure.

FIGS. 12A to 12F are flowcharts illustrating a process for manufacturing partition walls of the micro-partition structure according to one embodiment of the present disclosure.

### DETAILED DESCRIPTION

In the description of the present disclosure, it is to be understood that terms such as “front side”, “rear side”, “left side”, “right side”, “front end”, “rear end”, “end”, “longitudinal”, “lateral”, “vertical”, “top”, “bottom”, and the like indicate orientations or positional relationships based on the orientations or positional relationships shown in the drawings, and are merely used to facilitate description of the present disclosure and to simplify the description, rather than to indicate or imply that the referenced apparatus or elements must have a particular orientation or be constructed and operated in a particular orientation, and therefore should not be construed as limiting the present disclosure.

As used herein, terms such as “first”, “second”, “third”, “fourth”, and “fifth” are used to describe various elements, components, regions, layers and/or portions, and these elements, components, regions, layers and/or portions should not be limited by such terms. These terms are only used to distinguish one element, component, region, layer or portion from another. Unless the context clearly indicates otherwise, the terms “first”, “second”, “third”, “fourth”, and “fifth” as used herein do not imply any order or sequence.

As used herein and unless otherwise defined, terms such as “substantially” and “approximately” are used to describe and denote minor variations. When combined with an event or condition, such terms can include the precise instant at which the event or condition occurs as well as a proximate point in time close thereto. For example, when combined with a numerical value, such terms can encompass a variation range less than or equal to ±10% of that value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

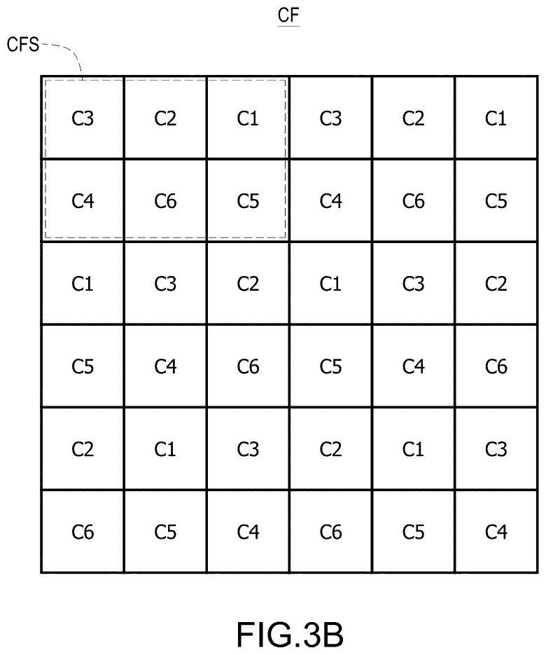

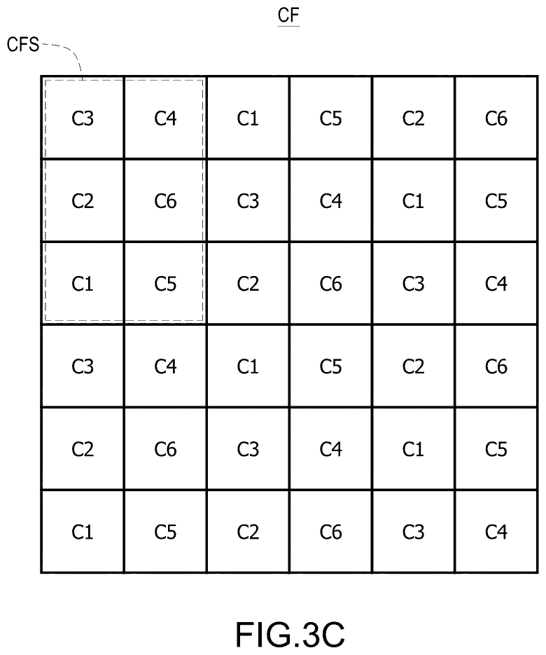

Referring to FIG. 2A, this figure shows a high-color-saturation and high-brightness color filter layer CF (hereinafter simply referred to as the color filter layer CF) applicable to a color display 100 having a color filter layer according to an embodiment of the present disclosure. The color filter layer CF includes a plurality of color filter unit sets CFS (as indicated by the dashed box). Each color filter unit set CFS is formed from at least six color filter blocks of different colors, for example, the color filter blocks C1 to C6 shown in FIG. 2A. In one embodiment of the present disclosure, these color filter blocks include a plurality of primary-color color filter blocks and a plurality of non-primary-color color filter blocks, and each color filter block has one-to-one correspondence with a pixel electrode. In one embodiment of the present disclosure, among the plurality of non-primary-color color filter blocks, at least one color filter block has a transmittable visible-light range greater than a transmittable visible-light range of at least one of the plurality of primary-color color filter blocks, the detail thereof will be described later.

According to one embodiment of the present disclosure, the color filter blocks include, for example, a blue color filter block C1, a green color filter block C2, a red color filter block C3, a yellow color filter block C4, a magenta color filter block C5, and a cyan color filter block C6. Among these color filter blocks, the blue color filter block C1, the green color filter block C2, and the red color filter block C3 are the above-described primary-color color filter blocks, whereas the yellow color filter block C4, the magenta color filter block C5, and the cyan color filter block C6 are the above-described non-primary-color color filter blocks. Among the non-primary-color color filter blocks, at least one color filter block (for example, the yellow color filter block C4) has a transmittable visible-light band that is greater than a transmittable visible-light band of at least one of the primary-color color filter blocks (for example, the blue color filter block C1). Alternatively, according to one embodiment of the present disclosure, one of the non-primary-color color filter blocks has a transmittable visible-light band that is greater than a transmittable visible-light band of a corresponding one of the primary-color color filter blocks; the term “corresponding” refers to the arrangement order of those colors along the frequency axis in the spectrum. For example, red corresponds to magenta, green corresponds to yellow, and blue corresponds to cyan. According to another embodiment of the present disclosure, the transmittable visible-light band is, for example, a full width at half maximum (FWHM) of light intensity in the visible-light region. Furthermore, according to one embodiment of the present disclosure, an average of the transmittable visible-light bands of a plurality of the non-primary-color color filter blocks is greater than an average of the transmittable visible-light bands of a plurality of the primary-color color filter blocks. In FIG. 2A, the arrangement of the color filter blocks of adjacent color filter cell sets has a specific displacement relationship. For example, in the two color filter unit sets CFS located respectively in the first and second columns at the upper left part of FIG. 2A, the blue color filter block C1 has one block displacement in the longitudinal direction.

Referring again to FIG. 2A, according to one embodiment of the present disclosure, the respective color filter blocks are distributed on the same plane, and there is no overlap between adjacent color filter blocks in the projection direction. However, it should be understood by those skilled in the art, when fabricating the color filter blocks, a portion of adjacent color filter blocks may overlap due to process factors. According to one embodiment of the present disclosure, an overlapping area between adjacent color filter blocks in the projection direction is less than 30% of an area of one color filter block. According to another embodiment of the present disclosure, an overlapping area between adjacent color filter blocks in the projection direction is less than 20% of an area of one color filter block. According to another embodiment of the present disclosure, for at least more than half of the color filter blocks, any two adjacent ones of the color filter blocks do not overlap with each other in the projection direction. In other words, according to the present disclosure, the color filter blocks may be distributed on different planes or on the same plane, as long as when viewed along the projection direction, an overlapping area between adjacent color filter blocks (even not on the same plane) in the projection direction is less than 30% or 20% of an area of one color filter block; or for at least more than half of the color filter blocks, any two adjacent ones of the color filter blocks do not overlap with each other in the projection direction. All of above variation fall within the scope in which the present disclosure can be implemented.

Referring to FIG. 2B, this figure shows a high-color-saturation and high-brightness color filter layer CF (hereinafter simply referred to as the color filter layer CF) applicable to a color display 100 having a color filter layer according to another embodiment of the present disclosure. According to another embodiment of the present disclosure, for each color filter block, it is not necessary to have an area identical to that of the corresponding pixel electrode. Instead, each color filter block may have a corresponding partial area, for example, an area that is 70% of the area of the corresponding pixel electrode, with the remaining 30% area serving as a light-transmitting portion. It should be understood that, for simplification of description, FIG. 2B only illustrates the color filter block configuration of the “color filter unit set CFS” located at the upper left part in FIG. 2A. However, those skilled in the art can modify the remaining color filter block configurations of FIG. 2A in accordance with the configuration disclosed in FIG. 2B.

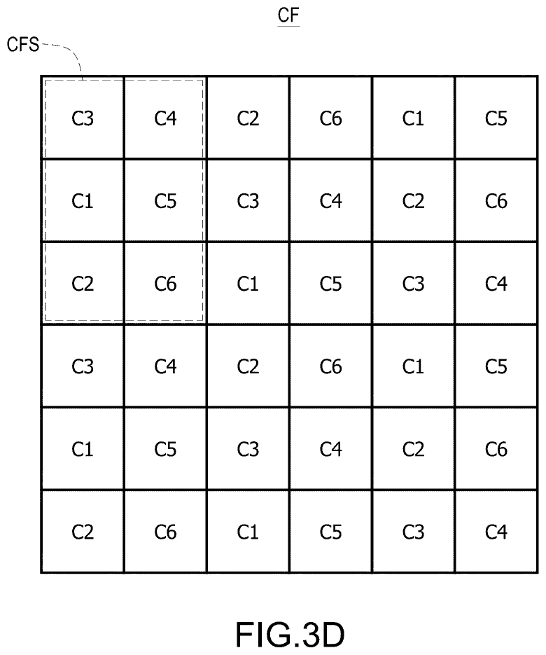

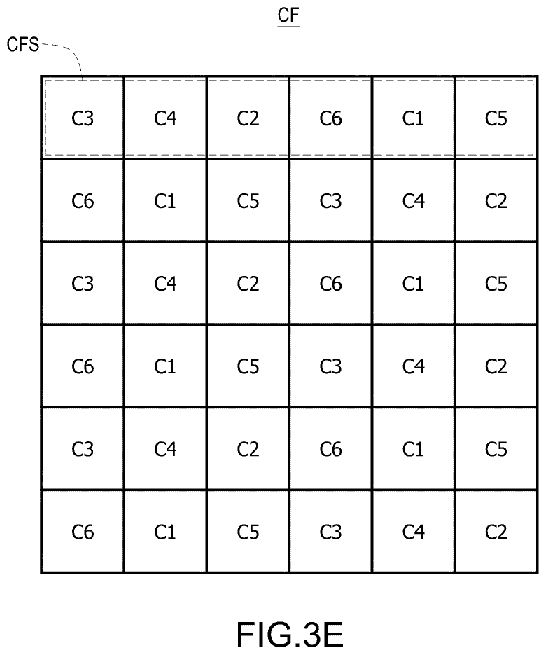

Referring to FIG. 3A, this figure shows a high-color-saturation and high-brightness color filter layer CF (hereinafter simply referred to as the color filter layer CF) applicable to a color display 100 having a color filter layer according to another embodiment of the present disclosure. The color filter layer CF includes a plurality of color filter unit sets CFS (as indicated by the dashed box). Each color filter unit set CFS is formed from at least six color filter blocks of different colors, for example, the color filter blocks C1 to C6 shown in FIG. 3A. In one embodiment of the present disclosure, the blue color filter block C1, the green color filter block C2, the red color filter block C3, the yellow color filter block C4, the magenta color filter block C5, and the cyan color filter block C6 may be arranged in any order with following limitation. With any one color filter block serving as a center, the colors of the eight adjacent color filter blocks are different from the color of the central color filter block. Taking the 3×3 grids (as indicated by the dashed box) at the lowest right corner in FIG. 3A as an example, the color of the central magenta color filter block C5 is different from the colors of the eight adjacent color filter blocks (C1, C4, C3, C6, C4, C1, C3, C2). This configuration of color filter blocks in the embodiment shown in FIG. 3A is mainly intended to improve the oblique stripe effect caused by the color filter block arrangement in conventional techniques.

Referring to FIG. 3B, this figure shows a high-color-saturation and high-brightness color filter layer CF (hereinafter simply referred to as the color filter layer CF) applicable to a color display 100 having a color filter layer according to another embodiment of the present disclosure. The color filter layer CF includes a plurality of color filter unit sets CFS (as indicated by the dashed box). Each color filter unit set CFS is formed from at least six color filter blocks of different colors. More specifically, each of the plurality of color filter cell sets CFS is formed by arranging three color filter blocks of red C3, green C2, and blue C1 and three color filter blocks of yellow C4, magenta C5, and cyan C6 in parallel-connection manner along vertical direction or in serial-connection manner along horizontal direction. In the present disclosure, the vertical direction is the upright direction when viewing the drawing, and the horizontal direction is the transverse direction when viewing the drawing. As shown in FIG. 3B, the three color filter blocks, namely, the red color filter block C3, the green color filter block C2, and the blue color filter block C1, and the other three color filter blocks, namely, the yellow color filter block C4, the magenta color filter block C5, and the cyan color filter block C6 may also be regarded as being alternately arranged in series along the horizontal direction. For example, the three color blocks in the first row at the upper left of FIG. 3B, namely the red color filter block C3, the green color filter block C2, and the blue color filter block C1, and the three color blocks in the third row at the upper left of FIG. 3B, namely the red color filter block C3, the green color filter block C2, and the blue color filter block C1, have an alternately arranged in-series relationship in the horizontal direction with the second row interposed therebetween.

Referring to FIG. 3C, this figure shows a high-color-saturation and high-brightness color filter layer CF (hereinafter simply referred to as the color filter layer CF) applicable to a color display 100 having a color filter layer according to another embodiment of the present disclosure. The color filter layer CF includes a plurality of color filter unit sets CFS (as indicated by the dashed box). Each color filter cell set CFS is formed from at least six color filter blocks of different colors. More specifically, each of the plurality of color filter cell sets CFS is formed by arranging three color filter blocks of red C3, green C2, and blue C1 and three color filter blocks of yellow C4, magenta C5, and cyan C6 in parallel-connection manner along horizontal direction or in serial-connection manner along vertical direction. In the present disclosure, the vertical direction is the upright direction when viewing the drawing, and the horizontal direction is the transverse direction when viewing the drawing.

As shown in FIG. 3C, the three color filter blocks, namely, the red color filter block C3, the green color filter block C2, and the blue color filter block C1, and the other three color filter blocks, namely, the yellow color filter block C4, the magenta color filter block C5, and the cyan color filter block C6 may also be regarded as being alternately arranged in series along the vertical direction. For example, the three color blocks in the first column at the upper left of FIG. 3C, namely the red color filter block C3, the green color filter block C2, and the blue color filter block C1, and the three color blocks in the third column at the upper left of FIG. 3C, namely the red color filter block C3, the green color filter block C2, and the blue color filter block C1, have an alternately arranged in-series relationship in the vertical direction with the second column interposed therebetween.

Besides, according to another embodiment of the present disclosure, the color filter layer CF includes a plurality of color filter unit sets CFS, and each color filter unit set CFS is formed from at least six color filter blocks of different colors. More specifically, the color filter blocks include a plurality of primary-color color filter blocks and a plurality of non-primary-color color filter blocks, and each color filter block has one-to-one correspondence to a pixel electrode. According to one embodiment of the present disclosure, the blue color filter block C1, the green color filter block C2, and the red color filter block C3 are the above-described primary-color color filter blocks, whereas the yellow color filter block C4, the magenta color filter block C5, and the cyan color filter block C6 are the above-described non-primary-color color filter blocks. Furthermore, each primary-color color filter block is formed by vertically overlapping two non-primary-color color blocks having different colors (see the detailed description below). Referring to FIG. 3D and also to FIGS. 3H to 3J, FIG. 3D shows a high-color-saturation and high-brightness color filter layer CF (hereinafter simply referred to as the color filter layer CF) applicable to a color display 100 having a color filter layer according to another embodiment of the present disclosure, and FIGS. 3H to 3J show layouts of three non-primary-color color block masks

In FIG. 3D, the primary-color color filter blocks, namely, the blue color filter block C1, the green color filter block C2, and the red color filter block C3 are respectively formed by stacking a non-primary-color magenta color block on a cyan color block, stacking a non-primary-color yellow color block on a cyan color block, and stacking a non-primary-color yellow color block on a magenta color block. More specifically, FIG. 3H shows a yellow mask layout according to the present disclosure, which includes yellow color blocks YE1, YE2, YE and so on. FIG. 3I shows a magenta mask layout according to the present disclosure, which includes magenta color blocks MA1, MA2, MA and so on. FIG. 3J illustrates a cyan mask layout according to the present disclosure, which includes cyan color blocks CY1, CY2, CY and so on. For example, by stacking the yellow color block YE1 of the yellow mask in FIG. 3H with the magenta color block MA1 of the magenta mask in FIG. 3I, the red color filter block C3 in the first row and first column of FIG. 3D can be obtained. By stacking the magenta color block MA2 of the magenta mask in FIG. 3I with the cyan color block CY1 of the cyan mask in FIG. 3J, the blue color filter block C1 in the first row and second column of FIG. 3D can be obtained. By stacking the yellow color block YE2 of the yellow mask in FIG. 3H with the cyan color block CY2 of the cyan mask in FIG. 3J, the green color filter block C2 in the first row and third column of FIG. 3D can be obtained. The remaining primary-color color filter blocks in FIG. 3D can be obtained in a similar manner. Furthermore, FIGS. 3E, 3F, and 3G respectively shows the high-color-saturation and high-brightness color filter layers CF (hereinafter simply referred to as the color filter layer CF) applicable to a color display 100 having a color filter layer according to other embodiments of the present disclosure. The primary-color color filter blocks in these color filter layers CF can also be provided by layouts of three non-primary-color color block masks similar to those shown in FIGS. 3H to 3J. Furthermore, the layouts of the three non-primary-color color block masks shown in FIGS. 3H to 3J are arranged with a positional shift relative to one another. Therefore, when fabricating the three non-primary-color color block masks shown in FIGS. 3H to 3J, only a single mask is needed and it is sequentially shifted to perform three photolithography processes where a total of three types of photoresists of different colors is used to complete the fabrication. In other words, the color filter layers CF shown in FIGS. 3D, 3E, 3F, and 3G can be manufactured with lower cost and a simpler process, and the yield can also be greatly improved. In the color filter layers CF shown in FIGS. 2A, 3A to 3G, the red color filter blocks, the blue color filter blocks, the green color filter blocks, the magenta color filter blocks, the yellow color filter blocks and the cyan color filter blocks together form 6 by 6 color filter block matrixes. The color filter block matrixes are arranged along vertical direction and horizontal direction to form the high-color-saturation and high-brightness color filter layer.

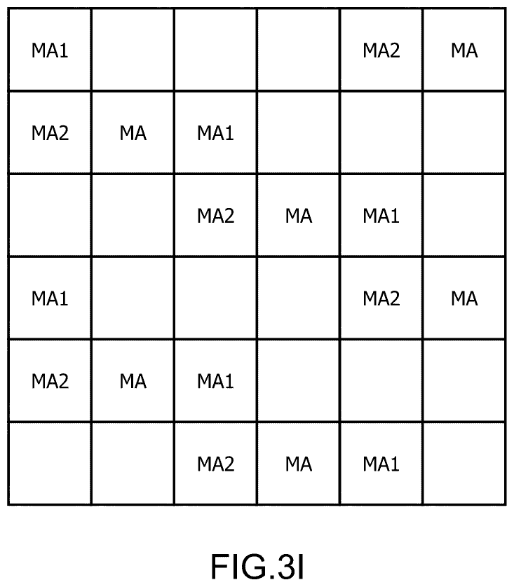

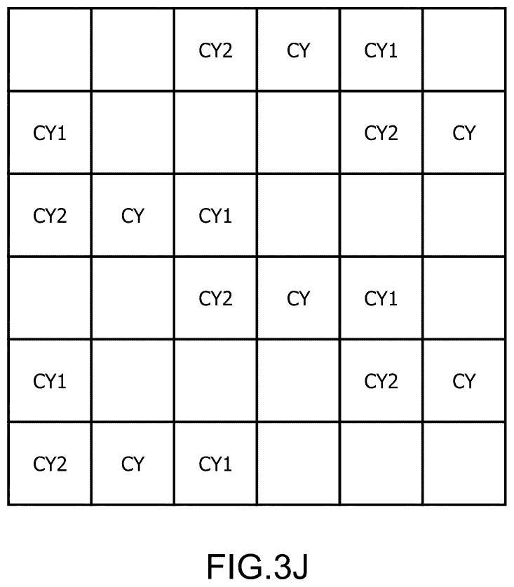

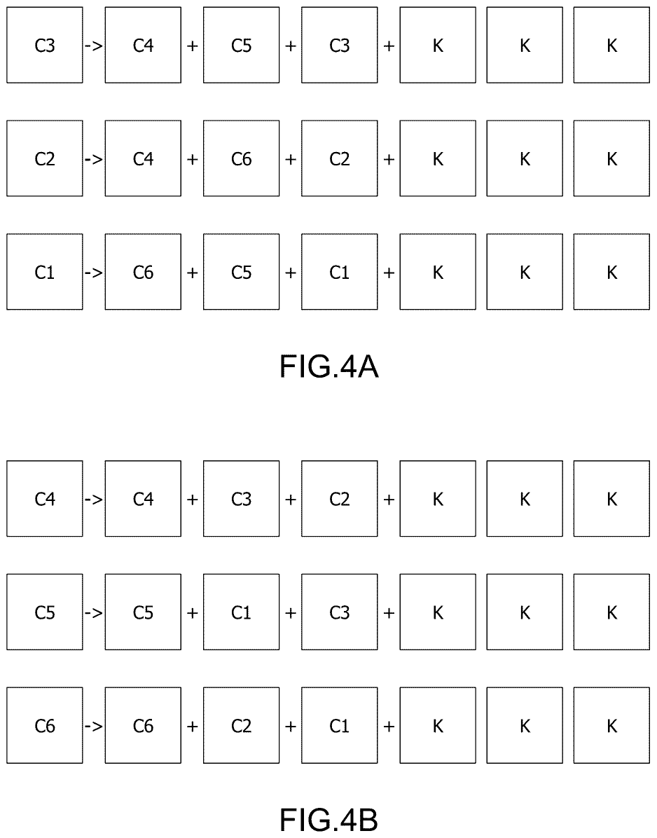

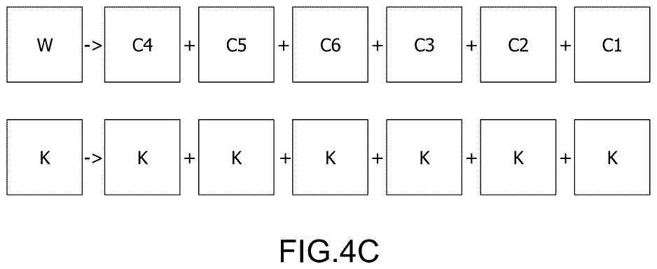

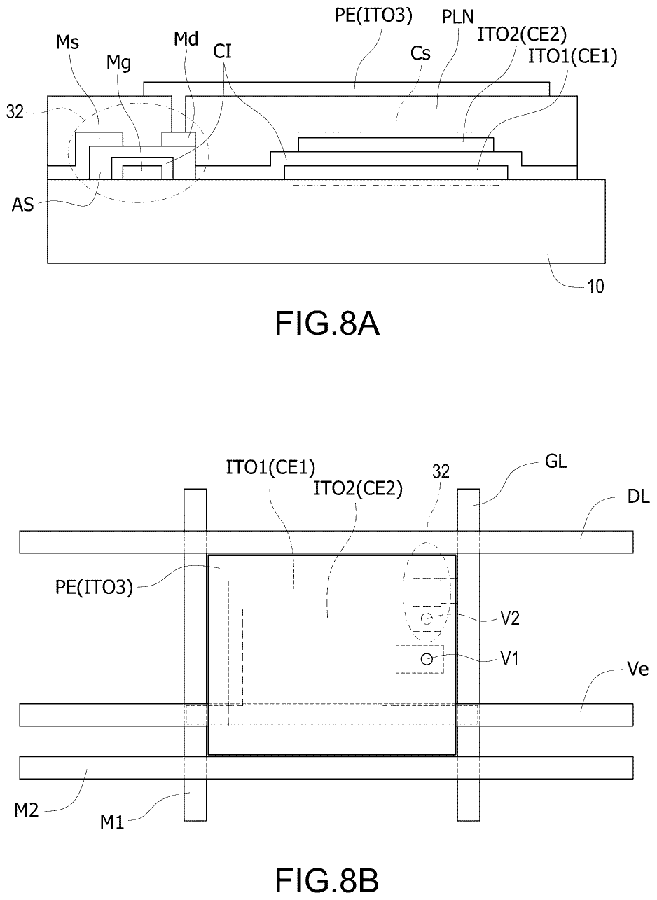

Referring to FIG. 5A, this figure shows a schematic diagram of a color display 100 according to the present disclosure. The color display 100 is, for example, an electrophoresis color display, and includes, from top to bottom, a common electrode layer 14, a display material layer 20 (for example, an electrophoresis layer), a color filter layer CF, a pixel electrode layer PEL, a thin film transistor layer 30 (details thereof will be described later with reference to FIGS. 8A and 8B), and a control substrate (first substrate) 10, the control substrate 10 including a first face 10A and a second face 10B. The display material layer 20 includes a plurality of hollow chambers (only one is shown), which may be, for example, a hollow cavity 22 as illustrated in this embodiment, a capsule, or a micro-partition structure (see the detailed description below). A colloidal solution 24 filled in each hollow cavity 22 contains a plurality of charged color particles 26 suspended therein (for example, charged black particles 26B and charged white particles 26W). The hollow cavity 22 serves as a container for electronic ink (or an electrophoresis material). The hollow cavity 22 is formed, for example, of an organic polymer material, and is used to contain the charged color particles 26. The color filter layer CF includes a plurality of color filter blocks C1 to C6 (with reference also FIGS. 2A and 2B). The pixel electrode layer PEL includes a plurality of pixel electrodes PE1 to PE6. The electrophoresis color display of FIG. 5A does not require an opposite substrate 12 as in the electrophoresis color display shown in FIG. 5B (see the detailed description below), and the common electrode layer 14 can be fixed onto the control substrate (first substrate) 10 by a frame sealant.

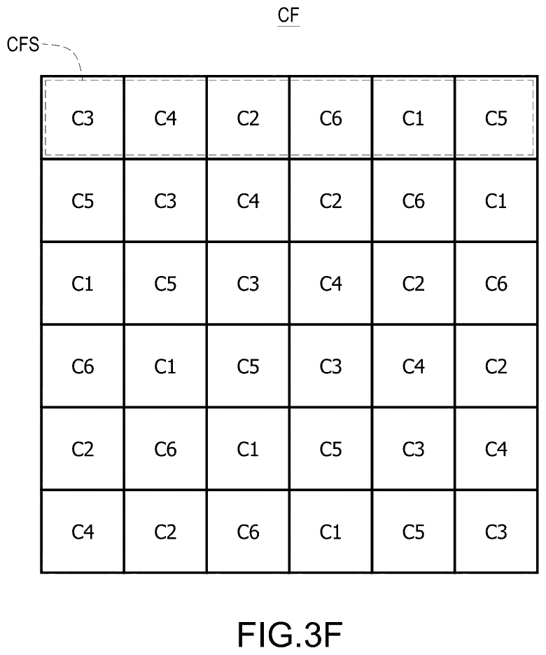

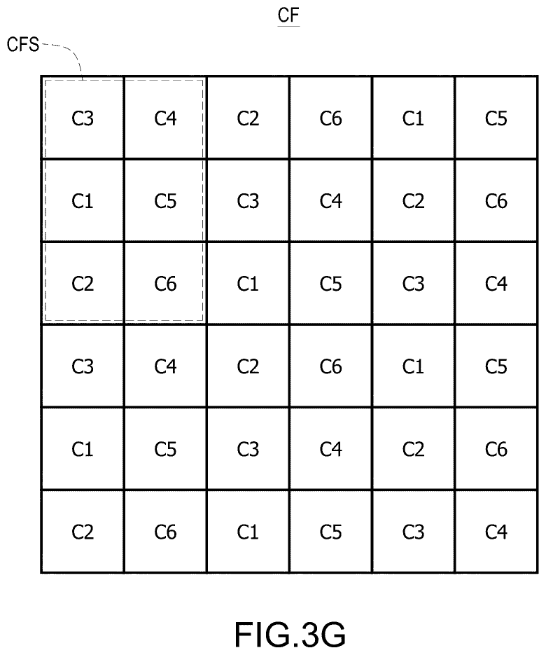

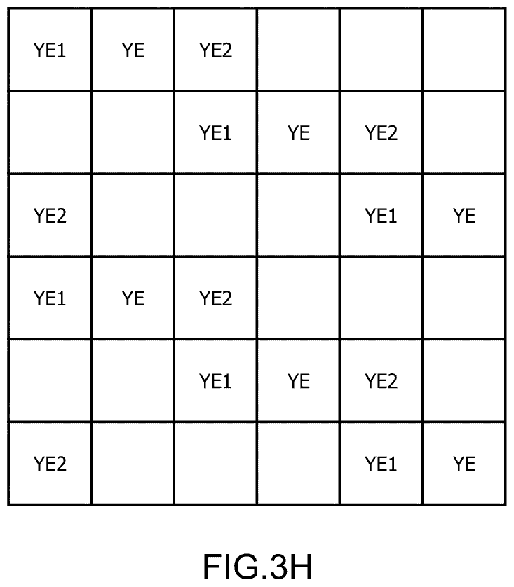

Referring to FIG. 4A, this figure shows the way to provide red color (R), green color (G), and blue color (B), respectively, by the color filter layer CF of FIG. 2A. According to the present disclosure, at least six color filter blocks (for example, the color filter blocks C1 to C6 of FIG. 2A) are combined to form one color filter unit set CFS capable of displaying full color.

If the color filter unit set CFS is to display red color, the pixel electrodes corresponding to the red color filter block C3, the yellow color filter block C4, and the magenta color filter block C5 of FIG. 2A are driven to attract or repel charged white particles, thereby causing the charged white particles to move and accumulate on sides corresponding to the above-mentioned color filter blocks, while black particles accumulate on sides corresponding to the remaining color filter blocks. As a result, red color, yellow color, and magenta color are additively mixed to form red color plus white color. In this case, the total luminance is Y+M+R+3Black=(R+G)+(R+B)+R+3Black=2R+1W+3Black.

If the color filter unit set CFS is to display green color, the pixel electrodes corresponding to the green color filter block C2, the yellow color filter block C4, and the cyan color filter block C6 of FIG. 2A are driven to attract or repel charged white particles, thereby causing the charged white particles to move and accumulate on sides corresponding to the above-mentioned color filter blocks, while charged black particles accumulate on sides corresponding to the remaining color filter blocks of FIG. 2A. As a result, green color, yellow color, and cyan color are additively mixed to form green color plus white color. In this case, the total luminance is Y+C+G+3Black=(R+G)+(G+B)+G+3Black=2G+1W+3Black.

If the color filter unit set CFS is to display blue color, the pixel electrodes corresponding to the blue color filter block C1, the magenta color filter block C5, and the cyan color filter block C6 of FIG. 2A are driven to attract or repel charged white particles, thereby causing the charged white particles to move and accumulate on sides corresponding to the above-mentioned color filter blocks, while charged black particles accumulate on sides corresponding to the remaining color filter blocks of FIG. 2A. As a result, magenta color and cyan color are additively mixed to form blue color plus white color. In this case, the total luminance is C+M+B+3Black=(B+G)+(B+R)+B+3Black=2B+1W+3Black.

Referring to FIG. 4B, this figure shows the way to provide yellow color (Y), magenta color (M), and cyan color (C), respectively, by the color filter unit set CFS of FIG. 2A. If the color filter unit set CFS is to display yellow color, the pixel electrodes corresponding to the yellow color filter block C4, the green color filter block C2, and the red color filter block C3 of FIG. 2A are driven to attract or repel charged white particles, thereby causing the charged white particles to move and accumulate on sides corresponding to the above-mentioned color filter blocks, while charged black particles accumulate on sides corresponding to the remaining color filter blocks. As a result, red color and green color are additively mixed to form yellow color, and in combination with yellow light that does not require mixing, the yellow luminance is further enhanced. In this case, the total luminance is Y+R+G+3Black=Y+Y+3Black=2Y+3Black.

If the color filter unit set CFS is to display magenta color (M), the pixel electrodes corresponding to the magenta color filter block C5, the blue color filter block C1, and the red color filter block C3 of FIG. 2A are driven to attract or repel charged white particles, thereby causing the charged white particles to move and accumulate on sides corresponding to the above-mentioned color filter blocks, while charged black particles accumulate on sides corresponding to the remaining color filter blocks. As a result, blue color and red color are additively mixed to form magenta color, and in combination with magenta light that does not require mixing, the magenta luminance is further enhanced. In this case, the total luminance is M+B+R+3Black=M+M+3Black=2M+3Black.

If the color filter unit set CFS is to display cyan color (C), the pixel electrodes corresponding to the cyan color filter block C6, the green color filter block C2, and the blue color filter block C1 of FIG. 2A are driven so as to attract or repel charged white particles, thereby causing the charged white particles to move and accumulate on sides corresponding to the above-mentioned color filter blocks, while charged black particles accumulate on sides corresponding to the remaining color filter blocks. As a result, green color and blue color are additively mixed to form cyan color, and in combination with cyan light that does not require mixing, the cyan luminance is further enhanced. In this case, the total luminance is C+G+B+3Black=C+C+3Black=2C+3Black.

Referring to FIG. 4C, this figure shows the way to provide white color (W) and black color (B), respectively, by the color filter unit set CFS of FIG. 2A. If the color filter unit set CFS is to display white color, the pixel electrodes corresponding to all the color filter blocks in this color filter unit set CFS, that is, the blue color filter block C1, the green color filter block C2, the red color filter block C3, the yellow color filter block C4, the magenta color filter block C5, and the cyan color filter block C6, are driven, under control of the thin film transistor layer 30, to apply a driving voltage so as to attract or repel charged white particles 26W, thereby causing the charged white particles 26W to move and accumulate on sides corresponding to all of the above-mentioned color filter blocks to reflect light. The pixel color is formed by additive mixing of the six colors of red, green, blue, yellow, cyan, and magenta to become white. In this case, the total luminance is Y+M+C+R+G+B=(R+G)+(R+B)+(G+B)+R+G+B=3W. Therefore, when the color display 100 displays white over the entire screen, its display luminance is not less than thirty percent of the luminance of incident light.

If the color filter unit set CFS is to display black color, the pixel electrodes corresponding to all the color filter blocks in this color filter unit set CFS, that is, the blue color filter block C1, the green color filter block C2, the red color filter block C3, the yellow color filter block C4, the magenta color filter block C5, and the cyan color filter block C6, are driven, under control of the thin film transistor layer 30, to apply a driving voltage so as to cause the charged black particles 26B to move and accumulate on sides corresponding to all of the above-mentioned color filter blocks to not reflect light, whereby regions corresponding to all of the color filter blocks are displayed as black color (K).

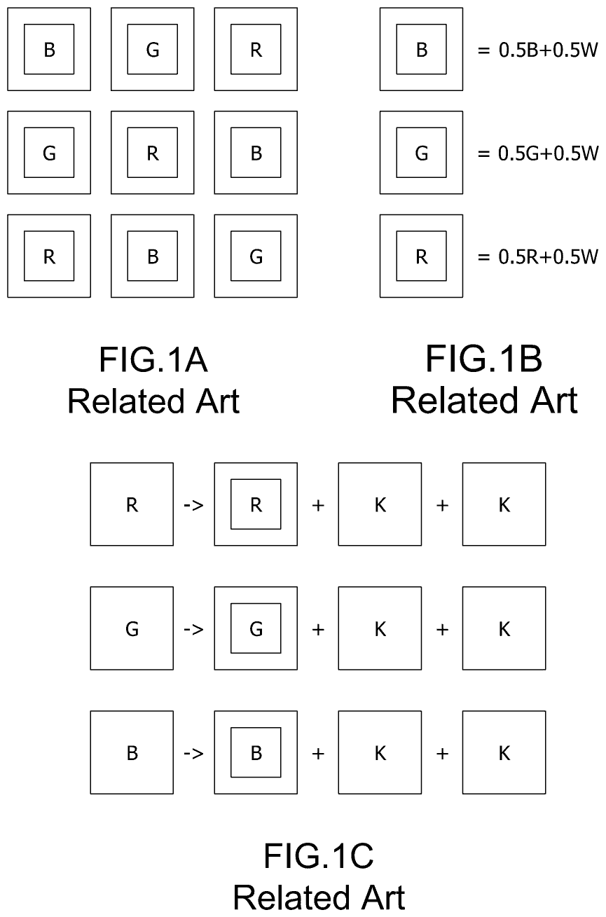

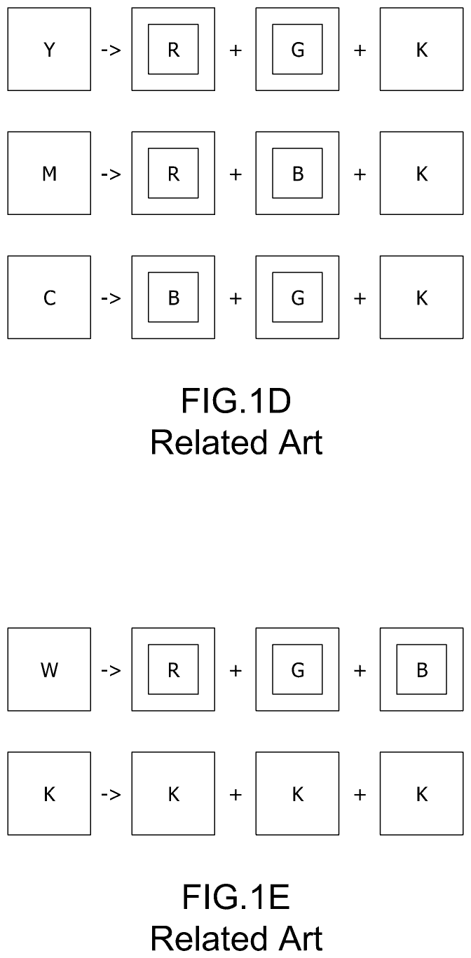

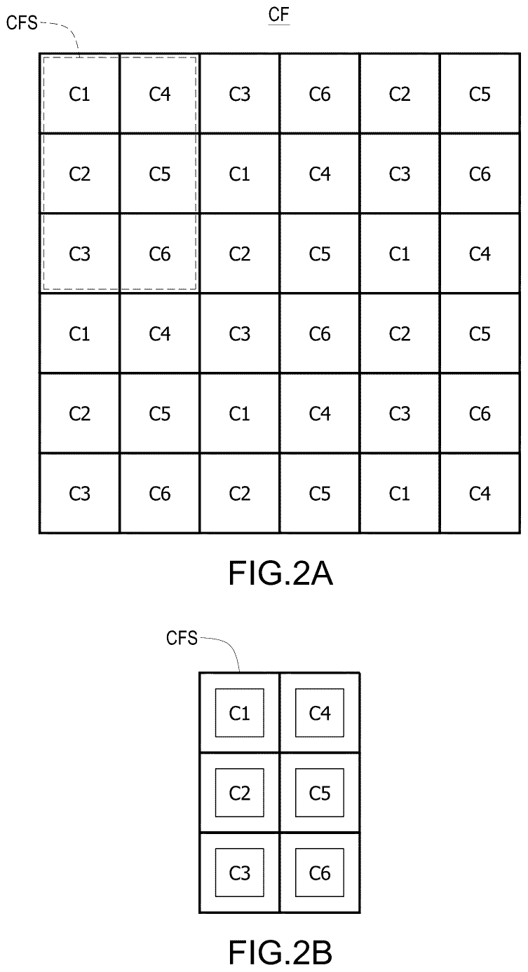

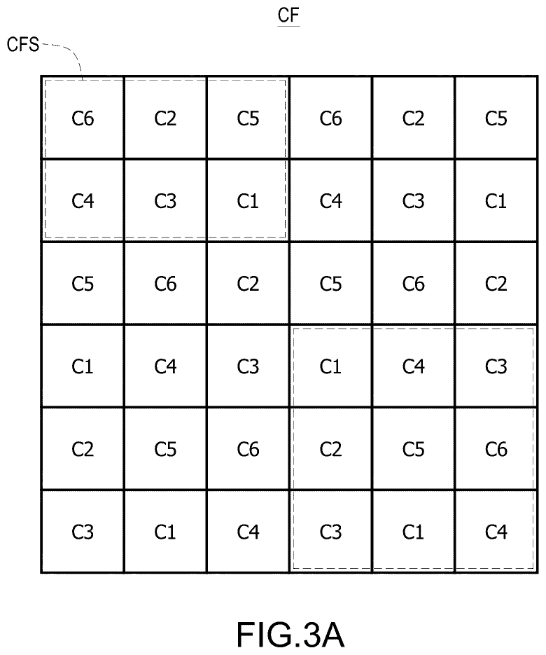

Referring to the table below, the color brightness and saturation of the color filter layer CF having the color filter unit sets CFS according to the present disclosure are compared with those of the conventional color filter layer CF shown in FIGS. 1A and 1B. Since each color filter unit set CFS of the present disclosure includes six color filter blocks, whereas the conventional color filter layer CF shown in FIGS. 1A and 1B includes three color filter blocks, the results of the conventional color filter layer CF shown in FIGS. 1A and 1B are doubled for better comparison

| | The present disclosure | Prior art (FIGS. 1A and 1B) |
|---|---|---|
| Red | 2R + 1W + 3Black | 1R + 1W + 4Black |
| Yellow | 2Y + 3Black | 1Y + 2W + 2Black |

As shown in the above table, when the color filter layer CF of the present disclosure displays red color, the color saturation thereof is twice that of the conventional technology, and the brightness thereof is higher because it dispensed with a black color. In addition, in comparison with the conventional technology, the present disclosure shows a similar trend for other primary colors blue and green. When the color filter layer CF of the present disclosure displays yellow color, the color saturation thereof is twice that of the conventional technology, but the brightness of the color filter layer CF of the present disclosure display is lower. However, the color filter layer CF of the conventional technology has the problem of appearing whitish when displaying yellow color because the brightness is too high. In addition, in comparison with the conventional technology, the present disclosure shows a similar trend for other non-primary colors magenta and cyan. From the above table, it is clear that the color filter layer CF of the present disclosure exhibits very small differences in terms of color-saturation and brightness when displaying both primary and non-primary colors. Therefore, the image display is more realistic. On the contrary, the color filter layer CF of the conventional technology is too bright when displaying non-primary colors and too dark when displaying primary colors, so the colors are unrealistic and the color-saturation is far inferior to that of the present disclosure.

FIG. 5B is a schematic diagram of a color display 100 according to another embodiment of the present disclosure. This color display 100 is, for example, a reflective electrophoresis color display and is similar to the embodiment of FIG. 5A. Nevertheless, the color display 100 in FIG. 5B further includes a second substrate 12 opposite to the control substrate 10. The opposite substrate 12 includes a third face 12A and a fourth face 12B. In manufacturing the color display 100 shown in FIG. 5B, after forming the thin-film transistor layer 30, the pixel electrode layer PEL, the color filter layer CF, and the display material layer 20 on the control substrate 10, a common electrode layer 14 is formed on the opposite substrate 12 and then the opposite substrate 12 is bonded to the display material layer 20, thereby fabricating the complete electrophoresis color display 100.

FIG. 5C is a schematic diagram of a color display 100 according to still another embodiment of the present disclosure. This color display 100 is, for example, a reflective electrophoresis color display and is similar to the embodiment on FIG. 5B. However, in the embodiment shown in FIG. 5C, the color filter layer CF of the color display 100 is moved from a position near the control substrate 10 to a position near the opposite substrate 12, namely to a position between the opposite substrate 12 and the common electrode layer 14. The color filter layer CF may also be located between the common electrode layer 14 and the display material layer 20, and near the third face 12A of the opposite substrate 12. In manufacturing the color display 100 in FIG. 5C, after forming the thin-film transistor layer 30, the pixel electrode layer PEL, and the display material layer 20 on the control substrate 10, a common electrode layer 14 and a color filter layer CF are formed on the opposite substrate 12 and then the opposite substrate 12 is bonded to the display material layer 20, thereby fabricating the complete electrophoresis color display 100.

FIG. 5D is a schematic diagram of a color display 100 according to still another embodiment of the present disclosure. This color display 100 is, for example, a reflective electrophoresis color display and is similar to the embodiment in FIG. 5C. However, in the embodiment shown in FIG. 5D, the color filter layer CF is moved to a position farther from the control substrate 10, that is, on the side of the opposite substrate farther from the control substrate 10 and closer to the fourth face 12B of the opposite substrate 12. The color filter layer CF is arranged on a filter substrate 19 and is located between the opposite substrate 12 and the filter substrate 19. In manufacturing this color display 100, after the thin-film transistor layer 30, the pixel electrode layer PEL, and the display material layer 20 are formed on the control substrate 10, and after the common electrode layer 14 is formed on the opposite substrate 12, the opposite substrate 12 is laminated with the display material layer 20, and then the filter substrate 19 on which the color filter layer CF is formed is bonded thereto, thereby producing a complete electrophoresis color display 100. In the embodiments shown in FIGS. 5A to 5D, the color filter layer CF includes a plurality of color filter unit set CFS, and these color filter unit sets CFS may, for example, be the color filter unit sets CFS shown in FIGS. 2A, 2B, and FIGS. 3A to 3I.

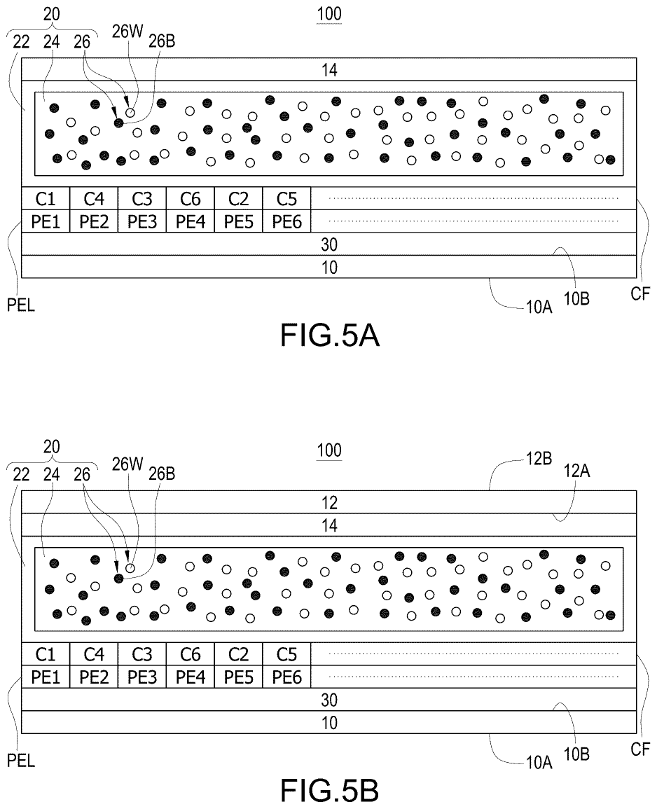

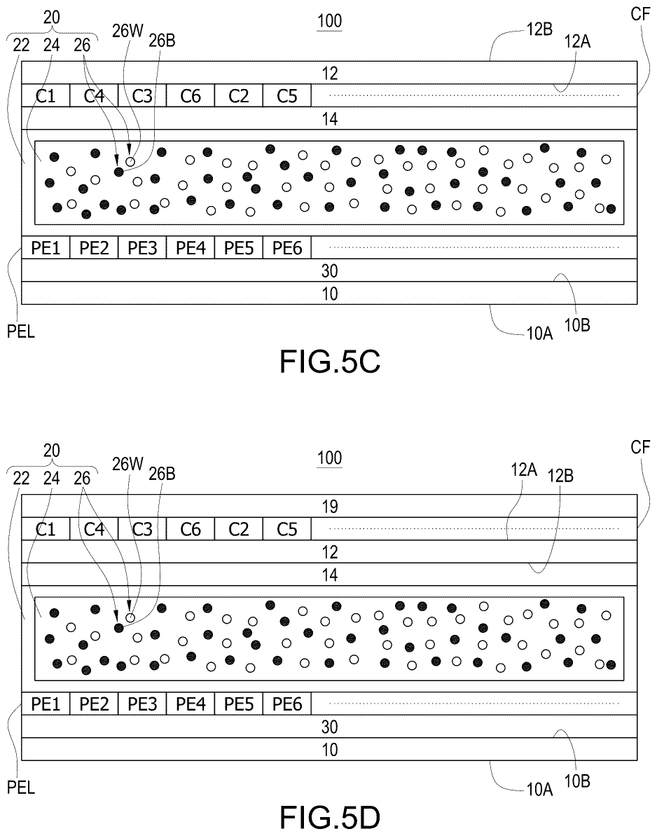

FIG. 6A is a schematic diagram of a color display 100 according to another embodiment of the present disclosure. The color display 100 is, for example, a reflective color liquid crystal display, and includes, from top to bottom, a polarization layer 18, an opposite substrate 12, a black matrix layer BM, a color filter layer CF, a common electrode layer 14, a display material layer 28 filled with a liquid crystal material, a pixel electrode layer PEL, a thin-film transistor layer 30, a control substrate 10, and a reflective layer 31.

FIG. 6B is a schematic diagram of a color display 100 according to still another embodiment of the present disclosure. The color display 100 is, for example, a reflective color liquid crystal display, and includes, from top to bottom, a polarization layer 18, an opposite substrate 12, a black matrix layer BM, a color filter layer CF, a common electrode layer 14, a display material layer 28 filled with a liquid crystal material, a pixel electrode layer PEL, a thin-film transistor layer 30′ having a reflective layer, and a control substrate 10. This embodiment differs from the embodiment of FIG. 6A in that the reflective layer is moved into the thin-film transistor layer, and the pixel electrode layer (not shown) within the thin-film transistor layer may be used as the reflective layer. In the embodiments shown in FIGS. 6A and 6B, the color filter layer CF includes a plurality of color filter unit sets CFS, and these color filter unit sets CFS may, for example, be the color filter unit sets CFS shown in FIGS. 2A, 2B, and FIGS. 3A to 3I.

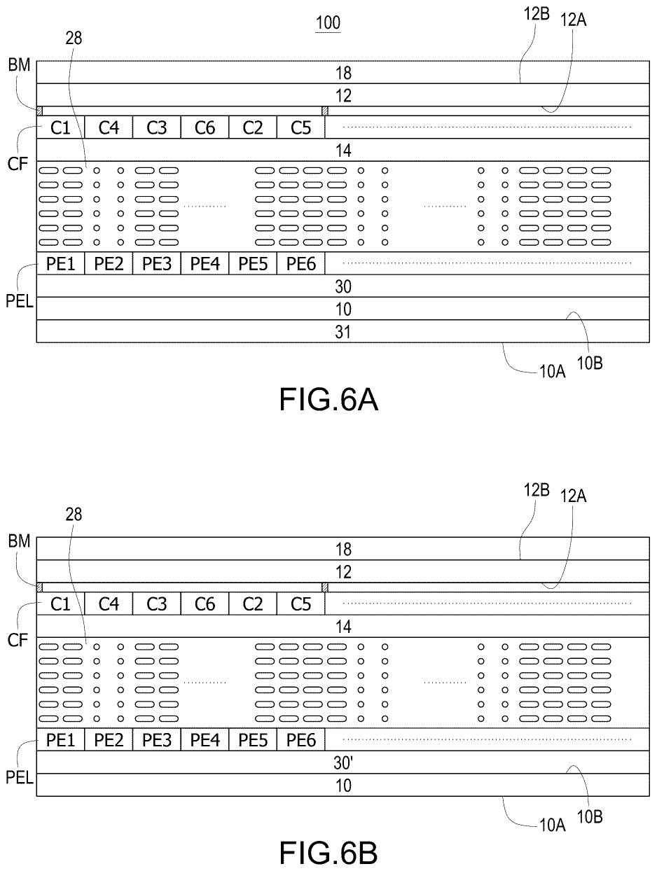

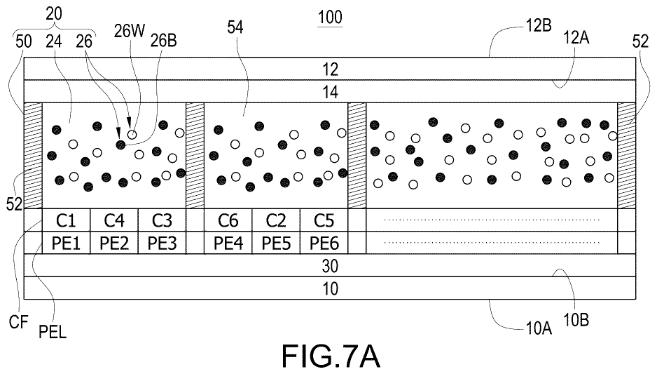

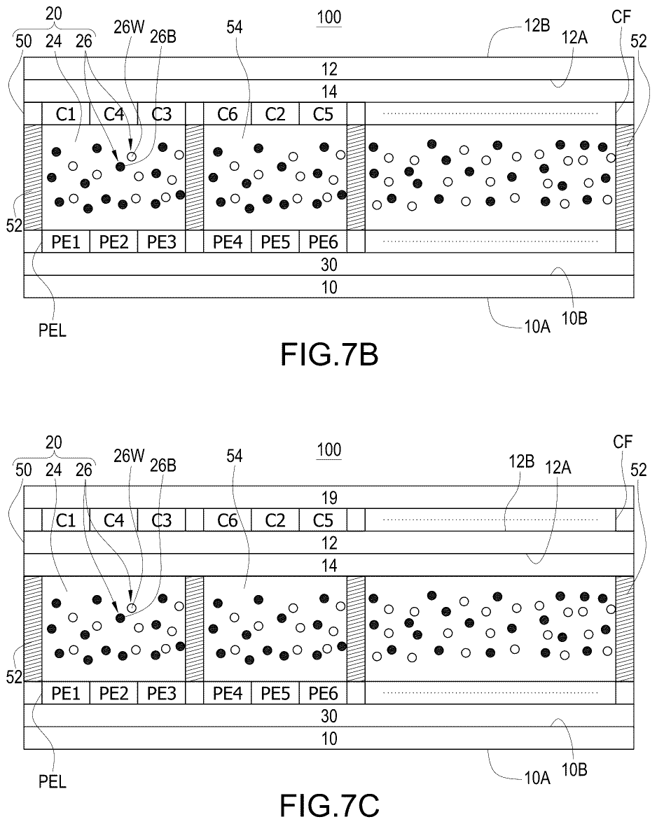

Please refer to FIG. 7A, this figure shows a schematic diagram of a color display 100 having a micro-partition structure and color filter layer. The color display 100 is, for example, a reflective electrophoresis color display, and includes, from top to bottom, an opposite substrate (second substrate) 12 having a third face 12A and a fourth face 12B, a common electrode layer 14, a display material layer 20 (for example, an electrophoresis layer), a color filter layer CF, a pixel electrode layer PEL, a thin-film transistor layer 30, and a control substrate (first substrate) 10, where the first substrate 10 includes a first face 10A and a second face 10B. The display material layer 20 (for example, the electrophoresis layer) includes a micro-partition structure 50 having a plurality of partition walls 52, and a colloidal solution 24 filled in each chamber 54 defined by the micro-partition structure 50. The colloidal solution 24 contains a plurality of suspended charged color particles 26 (for example, charged black particles 26B and charged white particles 26W). The chambers 54 defined by the micro-partition structure 50 serve as containers for electronic ink (or electrophoresis material), which will be detained later. The color filter layer CF includes a plurality of filter color blocks C1 to C6. The pixel electrode layer PEL includes a plurality of pixel electrodes PE1 to PE6. In manufacturing this color display 100, after the thin-film transistor layer 30, the pixel electrode layer PEL, the color filter layer CF, and the display material layer 20 are formed on the control substrate 10, the opposite substrate 12, on which the common electrode layer 14 is formed, is assembled with the control substrate 10 to construct a complete electrophoresis color display 100.

FIG. 7B is a schematic diagram of a color display 100 according to another embodiment of the present disclosure. The color display 100 is, for example, a reflective electrophoresis color display, and is similar to the embodiment in FIG. 7A. However, in the embodiment in FIG. 7B, the color filter layer CF of the color display 100 is moved from a position close to the control substrate 10 to a position close to the opposite substrate 12, namely, between the display material layer 20 and the common electrode layer 14, and close to the third face 12A of the opposite substrate 12. In manufacturing this color display 100, after the thin-film transistor layer 30, the pixel electrode layer PEL, and the display material layer 20 are formed on the control substrate 10, the opposite substrate 12 on which the common electrode layer 14 and the color filter layer CF are formed is assembled with the control substrate 10 to construct a complete electrophoresis color display 100.

FIG. 7C is a schematic diagram of a color display 100 according to another embodiment of the present disclosure. The color display 100 is, for example, a reflective electrophoresis color display, and is similar to the embodiment in FIG. 7B. However, in the embodiment of FIG. 7C, the color filter layer CF is moved to a position farther from the control substrate 10, that is, on the side of the opposite substrate farther from the control substrate 10 and closer to the fourth face 12B of the opposite substrate 12. The color filter layer CF is disposed on a filter substrate 19 and is located between the opposite substrate 12 and the filter substrate 19. In manufacturing this color display 100, after the thin-film transistor layer 30, the pixel electrode layer PEL, and the display material layer 20 are formed on the control substrate 10, the opposite substrate 12 already formed with the common electrode layer 14 is assembled with the control substrate 10, and then the filter substrate 19 on which the color filter layer CF is formed is bonded thereto, thereby constructing a complete electrophoresis color display 100.

In the color displays 100 shown in FIGS. 7B to 7C, similarly, the electrophoresis layer display material layer 20 includes a micro-partition structure 50 having a plurality of partition walls 52, and the colloidal solution 24 filled in each chamber 54 defined by the micro-partition structure 50 contains a plurality of suspended charged color particles 26. The chambers 54 defined by the micro-partition structure 50 serve as containers for electronic ink (or electrophoresis material), which will be detailed later. In the embodiments shown in FIGS. 7A to 7C, the color filter layer CF includes a plurality of color filter unit sets CFS, and these color filter unit sets CFS may be, for example, the color filter unit sets CFS shown in FIGS. 2A, 2B, and FIGS. 3A to 3I.

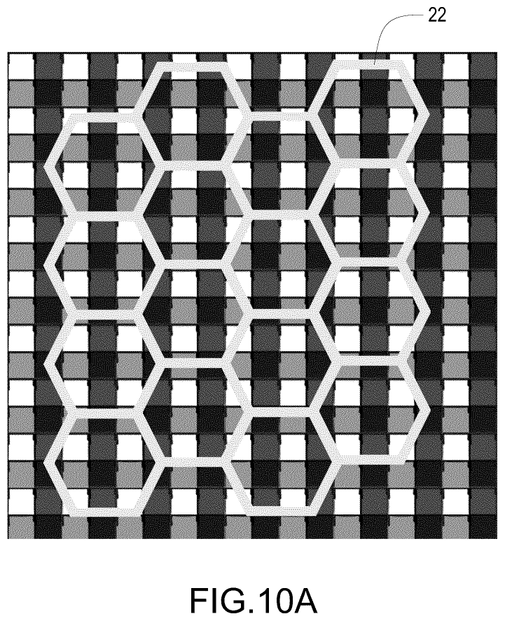

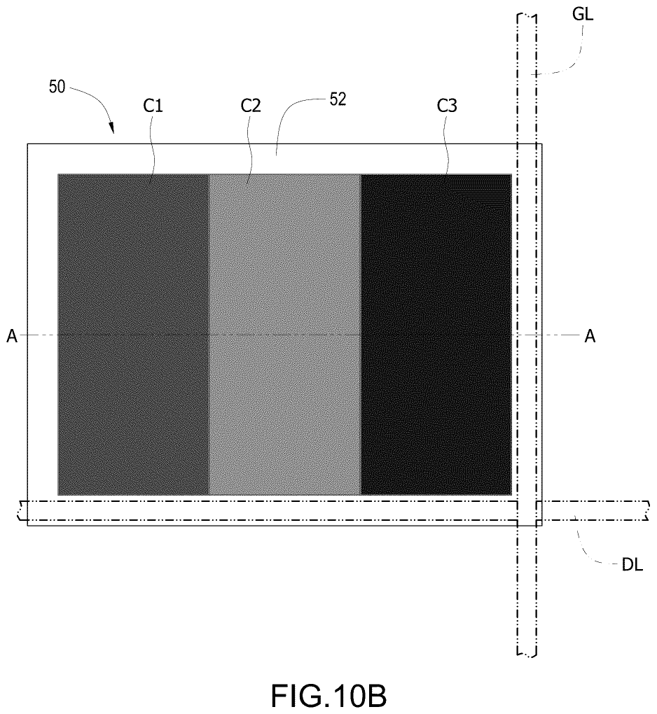

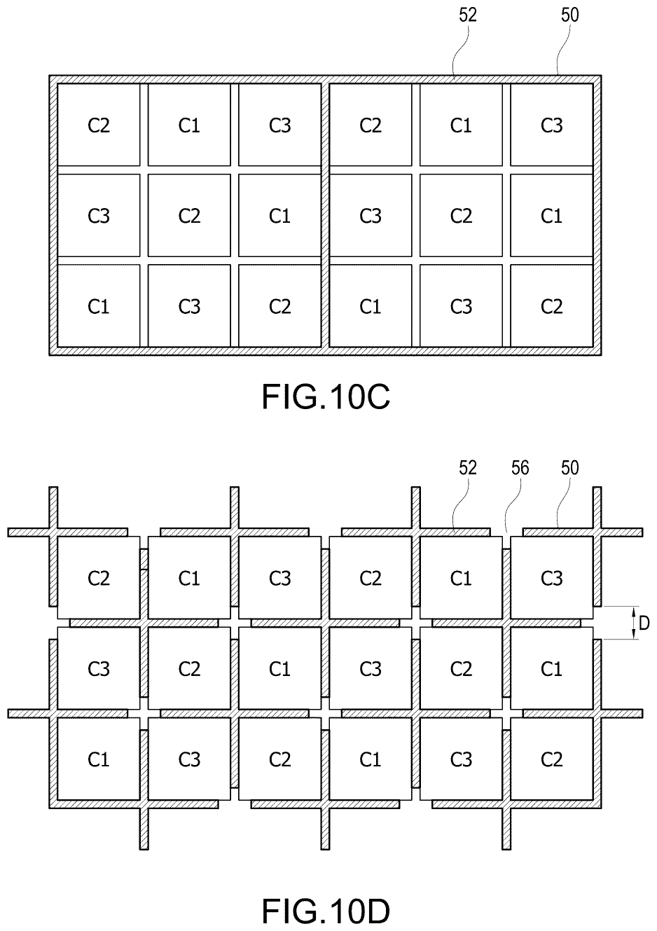

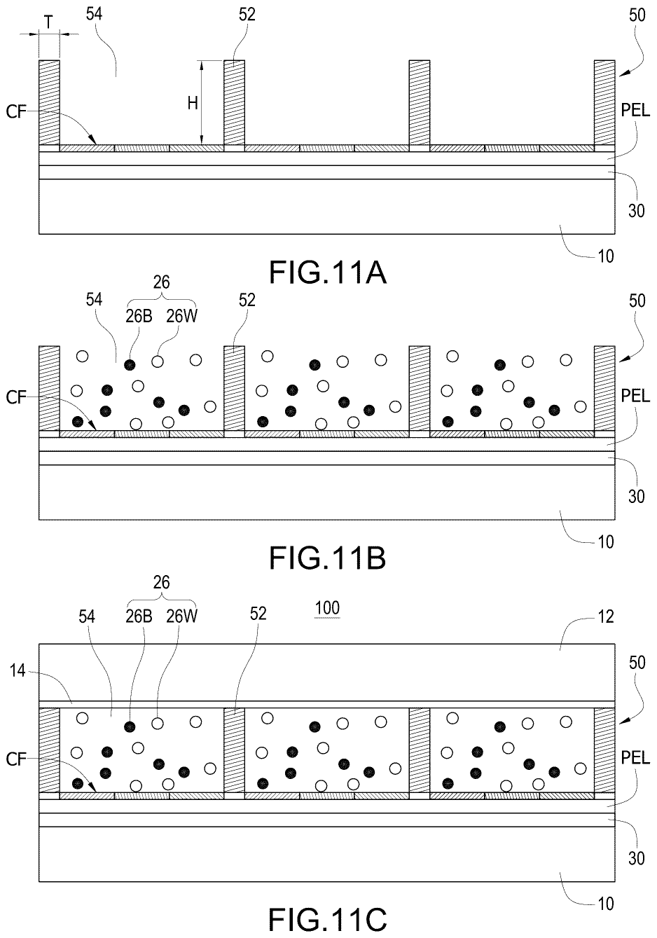

With reference to FIGS. 10A to 10D, those figures show a comparison between the micro-cup chambers of a conventional electrophoresis display and the micro-partition structure 50 of the present disclosure.

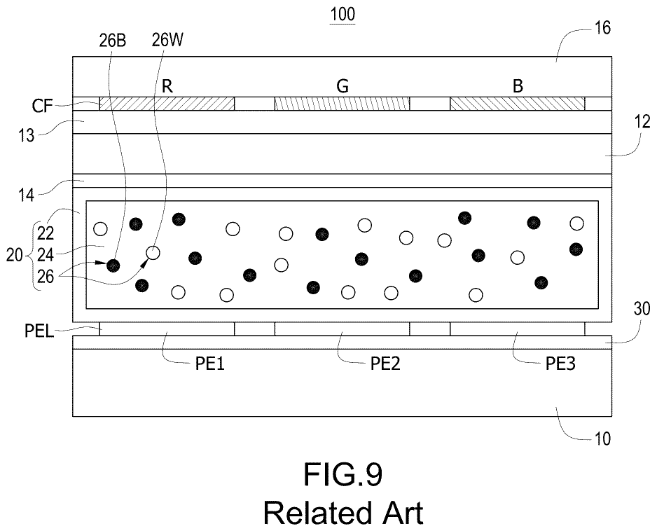

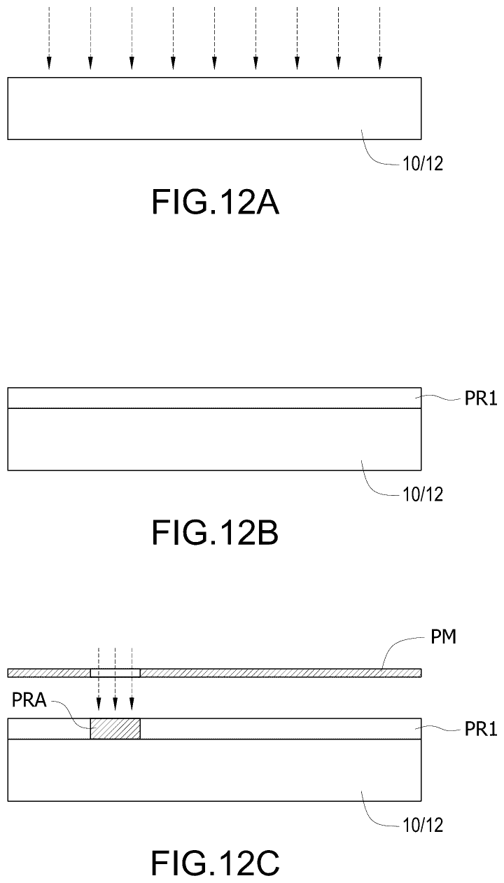

Refer to FIG. 10A which is a top-view diagram of the micro-cup chambers of the prior art electrophoresis display. The wall thickness of the micro-cup chambers (refer to FIG. 11A, the partition wall thickness of the present disclosure is marked as T, and the wall thickness of the micro-cup 22 in FIG. 10A is also the thickness extending along the parallel direction of the drawing) in prior art needs to be more than 10 μm to have sufficient support. Moreover, the micro-cup 22 of the prior art electrophoresis display, as viewed from an upper projection angle, mostly adopts a hexagonal compartment structure to increase the structural strength, the charged color particle may not arrive within the range of the micro-cup. The above may be regarded as the key factors affecting the aperture ratio of the display, there is no charged color particle 26 within the walls of the micro-cup in the prior-art electrophoresis display. When the micro-cup shown in FIG. 10A is bonded to the control substrate (e.g. the control substrate 10 as shown in FIG. 9), the electrodes on the control substrate are covered by the micro-cup, causing the display color to be partially obscured, forming background textures that affect imaging quality, and causing color distortion due to the uneven shielding position of the micro cup wall on the color filter layer. In addition, because the hollow micro-cup 22 shown in FIG. 10A is often attached to the control substrate with adhesive, it is not easy to align precisely. In other words, the micro-cup walls may be bonded to a position in the display area.

Refer to FIG. 10B, according to one embodiment of the present disclosure, the micro-partition is fabricated on the substrate instead of bonded (glued) to the substrate. This may accurately align the pixel electrode PE so that the partition wall 52 of the micro-partition structure 50 is formed on the non-display region between pixels. For the plurality of partition walls, as viewed along the projection direction on the viewing surface, the overlapping area of the partition wall and the pixel electrode may be as small as possible, at least less than 50% of the area of the pixel electrode. In other words, according to the design of the present disclosure, the micro-partition structure 50 and the partition wall 52 may be made into a rectangular structure close to the pixels and may fit the boundaries of the pixels without affecting the display. According to the present disclosure, for example, the photomask may be used for developing the pattern of the photoresist film to make the partition walls 52. The photoresist film may use materials with higher hardness (i.e. transparent photoresist made of acrylic). Furthermore, according to other embodiments of the present disclosure, the partition wall 52 of the micro-partition structure 50 may also be made of polymer materials (e.g. the planarization layer material, resin, or acrylic material). Furthermore, as shown in FIG. 10B, the partition wall 52 of the micro-partition structure 50 may be partially aligned with the gate line GL or the data line DL. In more detail, a plurality of partition walls 52 overlap with part of the data line DL and/or part of the gate line GL when viewed from the projection direction (e.g. perpendicular to the viewing surface direction). As shown in FIG. 10B, although the illustrated chamber formed by the micro-partition structure 50 has, in the projection direction, an area approximately equal to the area of three pixel electrodes (corresponding to the color filter blocks C1 to C3), according to the present disclosure, it is sufficient to achieve the effects of the present disclosure if the chamber area formed by the micro-partition structure 50 has, in the projection direction, an area greater than or equal to the area of two pixel electrodes.

Since the present disclosure uses hard polymer materials (e.g. transparent photoresist material) as the partition wall 52 of the micro-partition structure 50, the polymer materials hardness may reach pencil hardness equal to or more than 3H, much higher than the resin material used in the container of the micro cup of the prior art (hardness less than 1H). Therefore, the present disclosure may use the micro-partition structure with thinner wall thickness to support the weight and pressure of the upper and lower substrates, and the wall thickness T (refer to FIG. 11A) of the partition wall may be less than 15 μm. Refer to FIG. 10C, since the partition wall 52 of the micro-partition structure 50 of the present disclosure may be accurately positioned on the non-display region of the pixel (between pixels), it will not affect the display quality. Its high-precision characteristics may bring a good yield and reduce production costs. The greater advantage is that the expense and cost of using the prior art micro-cup to make electronic paper is eliminated, the cost of the optical adhesives and the loss of yield caused during bonding is saved by skipping the bonding of the substrate, and a thinner electrophoresis display may be made. In addition, the micro-partition structure 50 may also be made by using the planarization layer (PLN) material and using etching process to peel off the area other than the wall surface to complete the micro-partition structure. A thinner electrophoresis display may be made, and the electrophoresis layer 20 with less than 25 μm thickness may be easily made by the micro-partition structure 50 made through the present disclosure. Namely, the partition wall height H1 (refer to FIG. 11A) may be less than 25 μm. When the thickness of the electrophoresis layer of the electrophoresis display made by the micro-partition structure 50 of the present disclosure is thinner, the distance between the pixel electrode and the common electrode may be closer, the electric field magnitude may be greater, so that the electrophoresis layer may work at a lower driving voltage, the charged color particle may also move faster and the distance it needs to move is shorter to greatly improve the refresh speed of the screen. As a result, the refresh speed problem that plagues the electrophoresis display may be solved. This problem is especially important in colored electrophoresis displays.

Referring to FIGS. 10C and 7A, when manufacturing the electrophoresis color display 100 having the micro-partition structure according to the present disclosure, a photomask method as shown in FIGS. 3H to 3I may be adopted, in which a single photomask is used together with three photolithography processes to simultaneously form primary color filter blocks and non-primary color filter blocks, thereby accurately forming the color filter layer CF in the display region. Then, on the resulting structure, a photoresist film pattern is developed using a photomask to form the partition walls 52 of the micro-partition structure 50. Therefore, the partition walls 52 can be formed above the gate lines and data lines, and their cross-sectional width can be 10 μm, thereby the partition walls 52 substantially offset from the pixel electrodes along the projection direction to achieve more accurate display and improved aperture ratio. The chamber area surrounded by the partition walls 52 of the micro-partition structure 50 includes the display region of at least one pixel electrode, that is, at least the area of one color filter block. For example, as shown in FIG. 10C, a single micro-partition chamber includes the area of nine color filter blocks.

Refer to FIG. 10D which is a top-view diagram of the micro-partition structure in accordance with another embodiment of the present disclosure. According to this embodiment, the partition wall 52 (represented with a slashed figure to highlight its shape) of the micro-partition structure 50 adopts materials with higher hardness. If the partition wall 52 is applied to a bendable flexible electrophoresis display, the substrate used to make the micro-partition is a flexible substrate, the substrate may easily break and be damaged due to bending. In order to solve this problem, the micro-partition structure 50 and the partition wall 52 may be made into discontinuous shapes. Refer to the cross-shaped partition wall 52 in FIG. 10D. The gap 56 on the partition wall 52 may be used as a stretch and compress space when the substrate is bent causing the partition wall 52 to be squeezed. The gap 56 on the partition wall 52 may also serve as channels for the flow of the colloidal solution filled with charged particles, thereby improving the filling uniformity of the colloidal solution. According to an embodiment of the present disclosure, the area of the gap 56 is not more than 50% of the area of the partition wall 52, or the length D of the gap 56 is not more than 50% of the length of the partition wall 52. According to an embodiment of the present disclosure, the length D of the gap 56 may be more than 0.5 μm to provide a stretch and compress space for the partition wall 52 when it is squeezed, and for channels for the flow of the colloidal solution. In addition, the partition walls 52 shown in FIG. 10D are in a cross shape from top view so as to provide chambers where adjacent partition walls 52 have gaps. However, the partition walls 52 of the present disclosure may also have other shapes from top view, such as a T shape or a U shape, as long as there are gap 56 between at least some adjacent partition walls 52. Furthermore, although in the embodiment shown in FIG. 10D, the gap 56 on the partition walls 52 are uniformly distributed, it should be understood that, in actual fabrication, the gaps 56 may have different lengths due to process variations, and the gaps 56 need not penetrate through the partition walls 52 in the thickness direction, as long as they can provide expansion space when the partition walls 52 are compressed and serve as flow channels for the colloidal solution. In the embodiment of FIG. 10D, the area of each chamber is equal to the area of one color filter block only for ease of illustration, and the present disclosure is not limited by this example. When the area of a single chamber is smaller, it provide advantages for maintaining the uniformity of the distribution density of the charged particles of the electronic ink throughout the entire display. In this case, the gaps 56, during filling of the electronic ink and sealing and lamination, also function as microchannels to facilitate removal of bubbles, thereby improving process yield and enhancing quality.

FIGS. 11A to 11C are flow diagrams showing a method for forming the micro-partition structure 50 according to an embodiment of the present disclosure, and these diagrams can be used, for example, to fabricate the color display 100 having a micro-partition color filter layer as shown in FIG. 7A.

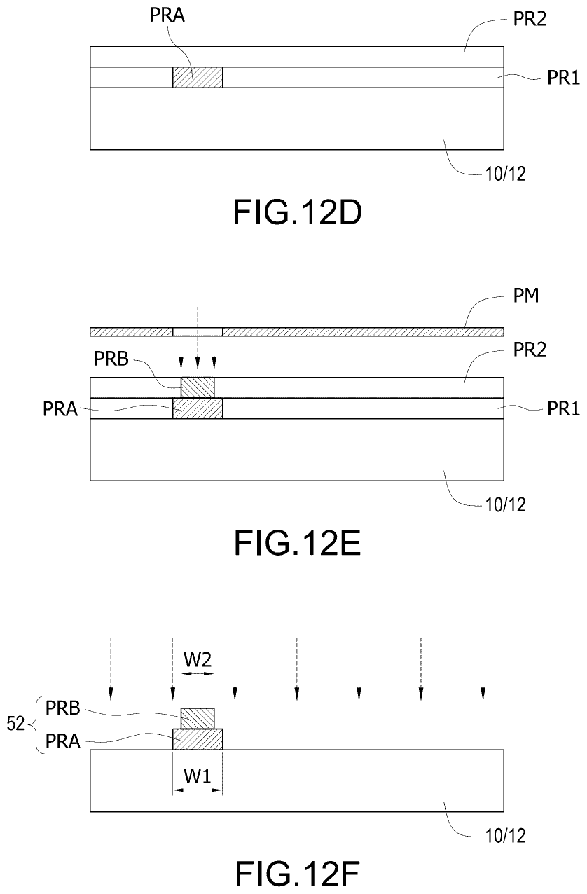

These schematic diagrams respectively show cross-sectional views, taken along line A-A of the structure of FIG. 10B, at different process stages. In this embodiment, the micro-partition structure 50 is formed on the color filter layer CF (that is, on the control substrate 10 side). Referring to FIG. 11A, first, the thin-film transistor layer 30, the pixel electrode layer PEL, and the color filter layer CF are formed on the control substrate 10. Subsequently, transparent photoresist and exposure/development processes are used to form the partition walls 52 of the micro-partition structure 50. During development, the developable depth of the photoresist is causally related to the light intensity and the number of exposures. In practice, for production cost and yield considerations, the thickness of the developable photoresist is usually less than 5 μm. When the thickness of the electrophoresis layer is too small, the number of color particles that can be accommodated is limited. This affects the number of stacked layers of the color particles and an insufficient number of stacked layers of color particles will affect reflectance, resulting in insufficient reflected light and reduced visible brightness. Therefore, the thickness of the electrophoresis layer is generally not less than 5 μm (the height H of the partition wall is not less than 5 μm). According to one implementation of the present disclosure, the thickness of the micro-partition structure 50 (that is, the height H of the partition wall) is greater than 5 micrometers and less than 25 micrometers, and the thickness T of the partition wall is less than or equal to 15 micrometers. In addition, referring also to FIG. 12F, the average cross-sectional width of the partition wall 52 of the micro-partition structure 50 is not greater than 15 micrometers.

Referring to FIG. 11B, after the partition walls 52 are formed, a colloidal solution containing charged black particles 26B and/or charged white particles 26W is filled into the chambers 54 defined by the partition walls 52. Then, referring to FIG. 11C, an opposite substrate bonding process is performed, in which an opposite substrate 12 having a conductive film (for example, a common electrode layer 14) is provided, and an optical adhesive (not shown) is used between the opposite substrate 12 and the partition walls 52, or a frame sealant is applied to the four sides of the display region, followed by lamination. After lamination, the two substrates are placed into a gas pressurizing chamber for heating and pressurizing, thereby forcing the colloidal solution to flow into and completely fill the voids in the micro-partition structure 50. Finally, the optical adhesive or the frame sealant is cured to complete fabrication of the electrophoresis display 100. As shown in FIG. 11C, the overlap area between the partition wall 52 and any pixel electrode is less than 50% of the area of the pixel electrode (namely, the electrode in the pixel electrode layer PEL). The above description is made with process flow to describe one method for manufacturing the electrophoresis color display 100 having the micro-partition structure 50 according to the present disclosure. Namely, this example forms the micro-partition structure 50 on the control substrate 10 and then laminates the control substrate 10 having the micro-partition structure 50 with the opposite substrate 12. However, according to the present disclosure, another method for manufacturing the electrophoresis color display 100 having the micro-partition structure 50 first forms the micro-partition structure 50 on the opposite substrate 12 and then laminates the opposite substrate 12 having the micro-partition structure 50 with the control substrate 10. Both methods are within the scope of the present disclosure. Below, with reference to FIGS. 12A to 12F, the process of forming the micro-partition structure 50 on a substrate is conceptually described, and those skilled in the art will understand that the illustrated process can be applied to form the micro-partition structure 50 on the control substrate 10 and/or the opposite substrate 12.

Refer to FIG. 12A to FIG. 12F, those figures illustrate the step of the manufacturing process of fabricating the partition wall 52 on the substrate side (e.g. the control substrate 10 side or the opposite substrate 12 side) in accordance with the embodiment of the present disclosure. According to the present disclosure, the partition wall 52 may be made directly on one surface of the substrate by using a transparent photoresist and exposure and development process. In addition, other structures may also exist on the surface of the substrate, such as the transparent pixel electrode layer PEL, the insulation layer, the protective layer, the thin-film transistor layer 30, the color filter layer CF, or the common electrode layer 14. Furthermore, the partition wall 52 is made directly on these structures by using transparent photoresist and exposure and development process. Furthermore, the flat layer PLN may also be added to other structures (e.g. the transparent pixel electrode layer PEL, the thin-film transistor layer 30, and the color filter layer CF) on the substrate, and then the partition wall 52 may be made by using transparent photoresist and exposure and development process. Therefore, although FIG. 12A to FIG. 12F schematically show that the initial structure is the substrate 10/12, the scope of the present disclosure is not limited to the presence or the non-presence of other structures thereon. As shown in FIG. 12A, first, the process cleans a substrate 10/12. The substrate may be the control substrate 10 or the opposite substrate 12, and there may be other structures on the surface to be cleaned. Then, refer to FIG. 12B, the process coats a first layer photoresist PR1, such as a transparent photoresist material, on the substrate 10/12. Then, refer to FIG. 12C, the process exposes the location where the partition wall 52 is to be formed by a photomask PM to carve out the first residual photoresist PRA (i.e. the first polymer material stack). According to an embodiment of the present disclosure, the first layer photoresist PR1 is a negative photoresist material, that is, the illuminated part may remain after development. According to another embodiment of the present disclosure, the first layer photoresist PR1 is a positive photoresist material, and the photomask PM needs to be designed accordingly. Then, refer to FIG. 12D, the process coats a second layer photoresist PR2, such as a transparent photoresist material, on the substrate 10/12. Then, refer to FIG. 12E, the process performs exposing, that is repeating exposing, the location where the partition wall 52 is to be formed by a photomask PM again to carve out the second residual photoresist PRB (i.e. the second polymer material stack). The residual range of the second layer photoresist may be less than the residual range of the photoresist of the previous layer, to form an upward-decreasing shape. Finally, refer to FIG. 12F, the process develops the resulting structure to leave the first residual photoresist PRA and the second residual photoresist PRB. The resulting structure (the second polymer material stack stacked on the first polymer material stack) by stacking is the partition wall 52 of the present disclosure. Through the above manufacturing process, by a repeated coating of photoresist, exposing, and final developing, the developer removes the unnecessary parts (hollowed areas), leaving a sufficiently-high micro-partition wall. The process may either repeat more than one photoresist coating, exposing and developing, or repeat more than two photoresist coating, exposing, and two developing. The area of each exposure may be reduced to allow the partition wall to be thinner, and the diameter of the partition wall may be reduced to less than 5 μm (W1-W2) for each layer. Refer to FIG. 11B, after fabricating the partition wall 52, under vacuum environmental conditions, the process fills in the colloidal solution in the chamber 54 defined by the partition wall 52 and this may avoid filling failure caused by air remaining in the micro-partition structure. The filling method may first use ODF coating equipment or an inkjet printing method to spray or print the colloidal solution into the display region. Since there may be alignment errors in each layer of exposure, in order to improve the yield of subsequent filling of the colloidal solution, according to an embodiment of the present disclosure, the design may adopt the wall thickness decreases as the stack grows. As a result, the problem that the wall surface becomes uneven and the contact area becomes smaller when filling the colloidal solution may be avoided. Furthermore, the problem that unfilled gaps are created when filling in the colloidal solution, causing more defective products, may be avoided. In practice, the exposed line width of the coated photoresist (i.e. the first polymer material stack) of the first layer may be the largest and then decrease with each layer. For example, the width (the width of the section) reduction of each layer of polymer material stack made for the partition wall is less than 5 μm. The shape of the wall of the micro-partition structure is thicker at the bottom and thinner at the top (namely tapered shape with a width-decreasing top). As shown in FIG. 12F, the width difference (amount of reduction) between the width W2 of the second polymer material stack and the width W1 of the first polymer material stack is less than 5 μm.

In the embodiment, the manufacturing process of the partition wall 52 of FIG. 12A to FIG. 12F may be performed after the pixel electrode layer PEL is made, or the manufacturing process of the partition wall 52 of FIG. 12A to FIG. 12F may be performed after the planarization layer PLN is made on the pixel electrode layer PEL. The material of the above planarization layer PLN may be organic insulating material, inorganic insulating material, or a combination thereof. According to one embodiment, the organic insulating material may be polyimide (PI), polyamic acid (PAA), polyamide (PA), polyvinyl alcohol (PVA), polyvinyl cinnamate (PVCi), poly methyl methacrylate, or other suitable photoresist materials or combinations thereof. In addition, the inorganic insulating material may be silicon oxide, silicon nitride, silicon oxynitride, siloxane, or a combination thereof.

For the color displays 100 of the above embodiments, reference is made to FIGS. 8A and 8B, which illustrate the structure and process of the thin-film transistor layer 30 and related elements on the control substrate 10 side according to the present disclosure.

According to the present disclosure, when manufacturing the electrophoresis display 100 (for example, the electrophoresis display shown in FIG. 5B), on the control substrate 10 side, a metal thin film is first formed on the upper surface of the control substrate 10 by a deposition process or a sputtering process, and a first metal layer M1 is patterned by a photolithography process, where the first metal layer M1 is used to form a gate metal Mg and a gate line GL. Subsequently, a transparent conductive material film is formed by a sputtering process and a first transparent conductive layer ITO1 (which can serve as a first storage electrode CE1) is patterned by a photolithography process. These two steps may also be performed in reverse order, that is, the first transparent conductive layer ITO1 is formed first and then the first metal layer M1 is formed. Next, a capacitor insulating layer CI (for example, SiNx, SiO2) for the storage capacitor Cs and an a-Si layer are deposited, and the semiconductor portion AS of the thin-film transistor in the thin-film transistor layer 30 is defined by a photolithography process. Subsequently, on the resulting structure, a metal thin film is formed by a deposition process or a sputtering process and a second metal layer M2 is patterned by a photolithography process. The second metal layer M2 is used to form a source metal Ms, a drain metal Md, and a data line DL. Then a transparent conductive material film is formed by a sputtering process and a second transparent conductive layer ITO2 (which can serve as a second storage electrode CE2) is patterned by a photolithography process. The above two steps may also be performed in reverse order, that is, the second transparent conductive layer ITO2 may be formed first and then the second metal layer M2 is formed. Subsequently, on the resulting structure, a planarization layer PLN is formed by a coating process and a photolithography process. Then a transparent conductive material film is formed by a sputtering process and the pixel electrodes PE of the pixel electrode layer PEL (that is, a third transparent conductive layer ITO3) are patterned by a photolithography process. The display material layer 20 may then be laminated onto or formed on the pixel electrode layer PEL. When laminating the display material layer 20, the display material layer 20 may contain hollow cavities (for example, hollow micro-cups 22). For example, a resin film is formed on a polymer substrate, recesses are embossed in the resin film by a roller to form the hollow micro-cup 22 structure, followed by curing, and the hollow micro-cup 22 structure serves as a container for electronic ink. A colloidal solution 24 containing charged color particles 26 is then injected into the hollow micro-cup 22 structure, and the top of the resulting structure is sealed with an adhesive and cured to form sealed cavities, thereby forming the display material layer 20 (that is, the electrophoresis layer). Details of the manufacturing process for micro-cup 22 structure can be found in Taiwan Patent Application No. 93100767. When the display material layer 20 is formed using the micro-partition fabrication method of the present disclosure, reference may be made to the methods disclosed in FIGS. 11A to 11C and 12A to 12F of the present disclosure. Subsequently, the portion of the opposite substrate 12 is fabricated, and a common electrode layer 14 is formed on the opposite substrate 12. Finally, the side of the control substrate 10 on which the display material layer 20 is formed is bonded to the opposite substrate 12 with an adhesive.

Referring also to FIG. 8B, the uppermost pixel electrodes PE may be made of a transparent conductive material, for example indium tin oxide (ITO) or a similar transparent conductive material, and are electrically connected, through vias V1, to the first transparent conductive layer ITO1 (first storage electrode CE1) of the storage capacitor Cs. The pixel electrodes PE are also electrically connected, through vias V2, to the drain metal Md. Although not fully shown in FIGS. 8A and 8B, in each embodiment of the present disclosure, the thin-film transistor layer 30 includes a plurality of thin-film transistors 32, a plurality of gate lines GL, and a plurality of data lines DL. The plurality of gate lines GL are arranged in a first direction, and the plurality of data lines DL are arranged in a second direction, with the first direction and the second direction being substantially perpendicular to each other. The pixel electrode layer PEL includes a plurality of pixel electrodes PE.

Referring also to FIGS. 8A and 8B, in the present disclosure, the plurality of gate lines GL and the plurality of data lines DL control turning on and off of the plurality of thin-film transistors 32, and thereby apply specific potentials to the plurality of pixel electrodes PE, so that charged color particles are attracted to one side of the pixel electrodes PE and an image is formed on one side corresponding to the plurality of transparent pixel electrodes PE. Referring further to FIGS. 5A, 5B, 7A, and 7B, the display image is viewed from the first face 10A of the first substrate 10 on the viewing side.

The present disclosure employs high-color-saturation and high-brightness color filter layer, which includes a plurality of color filter unit sets CFS, and each of the color filter unit sets CFS is formed by at least six different color filter blocks. Each of the color filter unit sets CFS includes multiple primary-color color filter blocks and multiple non-primary-color color filter blocks, thus enhance color-saturation and brightness. Furthermore, the electrophoresis display of the present disclosure can use transparent pixel electrodes to further improve the aperture ratio. For example, the aperture ratio can be made greater than eighty percent (80%).

Moreover, although not explicitly shown in FIGS. 8A and 8B, at least part of the area of each thin-film transistor 32 overlaps, in the projection direction, with a gate line GL or a data line DL to increase the aperture ratio. In addition, some of the plurality of gate lines GL and/or some of the plurality of data lines DL are formed of a transparent conductive material to increase the aperture ratio. When at least one of the above two conditions is satisfied, the aperture ratio can be further improved, and in combination with the transparent pixel electrodes, for example, the aperture ratio can be made greater than ninety percent (90%).

Furthermore, in the above embodiments, the plurality of color filter blocks includes non-primary-color color filter blocks, such as cyan (C), magenta (M), and yellow (Y) color filter blocks. According to one embodiment of the present disclosure, one of the non-primary-color color filter blocks has, within the visible range of 380 nm to 780 nm, a transmitted spectrum full width at half maximum (FWHM) exceeding 150 nm. In addition, the color filter layer CF of FIGS. 3A to 3G of the present disclosure may also be configured as that shown in FIG. 2B such that each color filter block does not need to have the same area as the corresponding pixel electrode, instead it may have a corresponding partial area. For example, each color filter block may have an area that is 70% of the corresponding pixel electrode area, with the remaining 30% area being a light-transmitting portion.

It shall be understood that the present disclosure may have other types of embodiments, and a person with ordinary skills in the art of the technical field of the present disclosure may make various changes and modifications corresponding to the present disclosure without deviating the principle and substance of the present disclosure; however, such corresponding changes and modification shall be considered to be within the claimed scope of the present disclosure.

What is claimed is:

1. An electrophoresis display with overlapped color blocks, the electrophoresis display comprising:
a first substrate comprising a first face and a second face, a thin-film transistor layer and a pixel electrode layer arranged on the second face, the thin-film transistor layer comprising a plurality of thin-film transistors, a plurality of gate lines, and a plurality of data lines, the pixel electrode layer comprising a plurality of pixel electrodes;
a color filter layer comprising a plurality of color filter unit sets, each of the color filter unit sets comprising at least six color filter blocks with different colors, the filter color blocks with different colors comprising a plurality of primary-color color filter blocks and a plurality of non-primary-color color filter blocks, each of the color filter blocks having one-to-one correspondence with one of the pixel electrodes, wherein each of the primary-color color filter blocks is formed by overlapping two non-primary-color color blocks with different colors;
a second substrate comprising a third face and a fourth face; and
a display material layer sandwiched between the first substrate and the second substrate, the display material layer being filled with a colloidal solution containing charged color particles of at least one color.

2. The electrophoresis display in claim 1, wherein when the electrophoresis display displays white color on full screen, a display brightness is not less than 30 percent of an incident light brightness.

3. The electrophoresis display in claim 1, wherein the plurality of non-primary-color color filter blocks comprise magenta color filter blocks, yellow color filter blocks, and cyan color filter blocks.

4. The electrophoresis display in claim 3, wherein the plurality of primary-color color filter blocks comprise red color filter blocks, blue color filter blocks, and green color filter blocks.

5. The electrophoresis display in claim 1, wherein the plurality of non-primary-color color filter blocks comprise at least two different colors, and one of the non-primary-color color filter blocks has, within a visible-light range of 380 nm to 780 nm, a transmitted-light spectrum with a full width at half maximum (FWHM) of greater than 150 nm.

6. The electrophoresis display in claim 1, wherein the color filter unit set comprises red color filter block, blue color filter block, green color filter block, magenta color filter block, yellow color filter block and cyan color filter block arranged in parallel along vertical direction or horizontal direction.

7. The electrophoresis display in claim 1, wherein the color filter unit set comprises red color filter block, blue color filter block, green color filter block, magenta color filter block, yellow color filter block and cyan color filter block arranged in series along vertical direction or horizontal direction.

8. The electrophoresis display in claim 1, wherein the color filter unit set comprises red color filter block, blue color filter block, green color filter block, magenta color filter block, yellow color filter block and cyan color filter block arranged alternately in series along vertical direction or horizontal direction.

9. The electrophoresis display in claim 1, wherein the plurality of color filter unit sets extend in horizontal and vertical directions to form a complete color filter layer.

10. The electrophoresis display in claim 9, wherein the color filter blocks of adjacent color filter unit sets have predetermined displacement relationship therebetween.

11. The electrophoresis display in claim 1, wherein red color filter blocks, blue color filter blocks, green color filter blocks, magenta color filter blocks, yellow color filter blocks and cyan color filter blocks together form 6 by 6 color filter block matrixes, the color filter block matrixes arranged along vertical direction and horizontal direction to form the color filter layer.

12. The electrophoresis display in claim 1, wherein one of the filter color blocks has a color different from colors of the surrounding adjacent color filter blocks.

13. The electrophoresis display in claim 1, wherein at least one of the color filter blocks has a transparent region.

14. The electrophoresis display in claim 1, wherein the color filter layer is arranged between the first substrate and the display material layer.

15. The electrophoresis display in claim 1, wherein the color filter layer is arranged between the second substrate and the display material layer.

16. The electrophoresis display in claim 4, wherein the color filter layer is formed by three photolithography processes using a same mask.

17. The electrophoresis display in claim 4, wherein in an area to be displayed with red color, the electrophoresis display is configured to control the charged white particles to move and accumulate on surfaces corresponding to the primary-color red color filter blocks and the non-primary-color magenta and yellow color filter blocks to display red color.

18. The electrophoresis display in claim 4, wherein in an area to be displayed with green color, the electrophoresis display is configured to control the charged white particles to move and accumulate on surfaces corresponding to the primary-color green color filter blocks and the non-primary-color cyan and yellow color filter blocks to display green color.

19. The electrophoresis display in claim 4, wherein in an area to be displayed with blue color, the electrophoresis display is configured to control the charged white particles to move and accumulate on surfaces corresponding to the primary-color blue color filter blocks and the non-primary-color magenta and cyan color filter blocks to display blue color.

20. The electrophoresis display in claim 4, wherein in an area to be displayed with yellow color, the electrophoresis display is configured to control the charged white particles to move and accumulate on surfaces corresponding to the non-primary-color yellow color filter blocks and the primary-color red and green color filter blocks to display yellow color.

21. The electrophoresis display in claim 4, wherein in an area to be displayed with cyan color, the electrophoresis display is configured to control the charged white particles to move and accumulate on surfaces corresponding to the non-primary-color cyan color filter blocks and the primary-color green and blue color filter blocks to display cyan color.

22. The electrophoresis display in claim 4, wherein in an area to be displayed with magenta color, the electrophoresis display is configured to control the charged white particles to move and accumulate on surfaces corresponding to the non-primary-color magenta color filter blocks and the primary-color blue and red color filter blocks to display magenta color.

23. The electrophoresis display in claim 4, wherein in an area to be displayed with white color, the electrophoresis display is configured to control the charged white particles to move and accumulate on surfaces corresponding to the non-primary-color yellow, magenta, and cyan color filter blocks and the primary-color blue, red, and green color filter blocks to display white color.
